(19) United States
(12) Patent Application Publication
(10) Pub. No.: US 2016/0055503 A1
(43) Pub. Date: Feb. 25, 2016

(54) SYSTEM AND METHOD FOR DISTRIBUTORLESS PRODUCT SUPPLY CHAIN MANAGEMENT

(71) Applicant: FLAVONESE PTE LTD, Singapore (SG)

(72) Inventor: Ming Chi CHAN, SINGAPORE (SG)

(21) Appl. No.: 14/485,786

(22) Filed: Sep. 14, 2014

(30) Foreign Application Priority Data
Aug. 22, 2014 (SG) 10201405155V

(51) Int. Cl. G06Q 30/02; G06Q 10/08

(52) U.S. Cl. CPC G06Q 30/0205; G06Q 30/0261; G06Q 10/087

(57) ABSTRACT

A new product introduction system is configured for (a) introducing new products into a target geographical without authorized or recognized distributors for such products; and (b) providing particular types of new product supply chain management services within the target geographical area. The system receives a target product verification request from a product seeker's computing device, and extracts a product image for determination of whether a product depicted therein is available in the target geographical area. The system maintains a cumulative count of target product verification requests corresponding to the product for estimating product popularity in the target geographical area. If no distributor exists, the system receives venture orders for the product from venture investors' computing devices, and places such orders with a product source outside the target geographical area. The system manages online product sales in the target geographical area, and automatically apportions online sales revenues among the venture investors.

### TECHNICAL FIELD

The present disclosure relates generally to systems and methods for automated product supply chain management. Particular aspects of the present disclosure are directed to a computer/communications network based system and method for identifying, rating/evaluating, ordering, selling, and reordering products such as food/beverage products for introduction into and distribution within a target geographical area in situations in which an authorized or recognized product distributor does not exist within the target geographical area. Aspects of the present disclosure additionally relate to automatically distributing online product sales profits among product investors associated with or within the target geographical area.

### BACKGROUND

A tremendous variety of products are available for purchase in different markets of the world. However, many products (e.g., new or recently introduced products) are available only in a limited number of markets, for instance, particular markets in which distributors for the products have been established. Each distributor imports specific types of products (e.g., specific product brands) into predetermined geographical areas or territories, and subsequently typically offers such products for sale to retailers therein. Various products lack established distributors in one or more markets in which significant product demand may exist.

When a small to medium sized business located in a particular geographical area has an interest in importing a product for which an authorized or recognized distributor in this geographical area does not exist, the small to medium sized business can be at a significant disadvantage with respect to the ability to obtain a favorable cost for obtaining the product from a manufacturer or distributor external to this geographical area, particularly if an estimated product turnover or volume is below a minimum order quantity that the external manufacturer or distributor normally supplies. Additionally, a small to medium sized business may lack sufficient resources for accurately or reasonably accurately estimating the extent to which a product under consideration for direct importation into its geographical area, which lacks an authorized or recognized distributor for the product, would be successful or popular in this geographical area prior to the product's importation therein. Furthermore a small to medium sized business may not be readily capable of sampling on a regular or periodic basis a wide variety of products for which authorized or recognized distributors do not yet exist in their geographical area.

Unfortunately, a straightforward, efficient, and cost effective manner by which a product can be introduced or imported into a given geographical area for which an authorized or recognized distributor has been established does not exist. Furthermore, a straightforward, efficient, and cost effective manner by which a product's popularity can be gauged or estimated prior to its importation into such a geographical area also does not exist.

A need exists to overcome the foregoing problems.

### SUMMARY

An aspect of the present disclosure is directed to a process for managing the introduction of a product into a target geographical area in which the product is unavailable from an authorized or recognized distributor. Such a process can include: generating a set of target product verification requests by way of a set of seeker computing devices including a first seeker computing device, where each seeker computing device is configured for executing an application program for selectively (a) capturing and/or receiving in response to user input information corresponding to a product, including at least one image of the product, and (b) electronically communicating in response to user input a target product verification request over an electronic network to a target product verification request processing system, wherein the target product verification request includes the at least one image of the product and information corresponding to the target geographical area; receiving a first target product verification request corresponding to a first product from the first seeker computing device at the target product verification request processing system, the first target product verification request including at least a first image of the first product and information corresponding to the target geographical area; automatically extracting the first image of the first target product from the first product verification request; determining using the first image of the first product whether the first product is already available for purchase within the target geographical area by way of (a) an authorized or recognized distributor established for the target geographical area, or (b) online orders submitted to an online purchase management system configured for managing online sales of the first product for delivery or pickup in the target geographical area in the absence of an authorized or recognized distributor for the first product in the target geographical area; and electronically communicating product availability information to the first seeker computing device in the event that the first product is already available for purchase in the target geographical area, the product availability information comprising data corresponding to at least one business or at least one map location within the target geographical area from which the first product is available for purchase.

Determining whether the first product is already available for purchase within the target geographical area can include automatically submitting the first image of the first product to a search engine or search service providing image-based search and recognition functionality.

The set of seeker computing devices can include a plurality of seeker computing devices (e.g., dozens, hundreds, or thousands of seeker computing devices), and the process can further include performing product identification operations involving designating the first product as a yet-to-be-identified product; receiving a plurality of product identification submissions corresponding to the yet-to-be-identified first product from the plurality of seeker computing devices, each product identification submission including a potential product name for the first product; determining a most frequently submitted potential product name for the first product based upon the plurality of product identification submissions; and selecting the most frequently submitted potential product name as the most likely or actual name of the first product. The process identification operations can additionally include identifying a reference image corresponding to the first product; and posting the reference image of the first product to a product recognition/identification graphical user interface (GUI) provided by each of the plurality of seeker computing devices. Each seeker computing device within the plurality of seeker computing devices can be associated with a seeker identifier (ID). The product identification operations can additionally involve determining a total number T of seeker IDs associated with the most frequently submitted potential product name; determining a set of k of seeker IDs associated with earliest product identification submissions within the plurality of product identification submissions that included the most frequently submitted potential product name, where k<T; and associating an electronic credit or award (e.g., for online purchases of products for which target product verification requests had been received and processed) with each seeker ID within the set of k seeker IDs.

The process can further include: determining using the first image of the first product that the first product is not presently available for purchase within the target geographical area; receiving at the target product verification processing system a set of subsequent target product verification requests corresponding to the first product and the target geographical area; and at least one of automatically determining a current estimated popularity of the first product in the target geographical area; and automatically determining whether the first product satisfies an estimated popularity criterion with respect to the target geographical area. The process can also include communicating to the first seeker computing device the current estimated popularity of the first product in the target geographical area and/or an indication of whether the first product satisfied the estimated popularity criterion with respect to the target geographical area.

Determining whether the first product satisfies the estimated popularity criterion with respect to the target geographical area can include: determining a cumulative number of target product verification requests corresponding to the first product and the target geographical area that were received during a predetermined monitoring period that temporally extends past the receipt of the first target product verification request; and determining whether the cumulative number of target product verification requests meets or exceeds a minimum estimated popularity threshold for the first product.

The process can additionally include: receiving rating data corresponding to the first product from a set of rating event computing devices at a product rating event at which the first product is presented, each rating event computing device associated with a testing member attending the product rating event; automatically generating rating statistics corresponding to the first product based upon the rating data; and automatically communicating the rating statistics over an electronic network to a plurality of testing member computing devices and a plurality of trading member computing devices external to or remote from the product rating event.

Furthermore, the process can include: receiving a plurality of venture orders by way of communication between the plurality of testing member computing devices and/or the plurality of trading member computing devices and a venture order processing system, where each venture order corresponds to a testing member or a trading member and indicating an order quantity and a selling price objective corresponding to the first product; generating and placing an aggregate venture order directed to a product source external to the target geographical area based upon the plurality of venture orders; allocating stock of the first product received in the target geographical area as a result of the aggregate venture order for online sales of the first product that are deliverable or receivable in the target geographical area; processing online orders for the first product for receipt or delivery in the target geographical area; determining a distributable revenue amount from online sales of the first product for receipt or delivery in the target geographical area; and automatically apportioning the distributable revenue amount among testing members and trading members in a manner correlated with testing member and trading member venture orders and allocations of stock of the first product for online sales. Automatically apportioning the distributable revenue amount can include apportioning (a) costs or values corresponding to online sales of the first product, (b) administrative fees corresponding to the first product, and (c) online sales profits corresponding to the first product among testing members and trading members in a manner correlated with first product quantities or first product selling price objectives in testing member and trading member venture orders and the allocation of stock of the first product for online sales. Receiving online orders, determining the distributable revenue amount, and automatically apportioning the distributable revenue amount can occur on a recurring basis (e.g., a monthly or quarterly basis) in accordance with a predetermined recurring settlement period.

An aspect of the present disclosure is directed to a system for managing the introduction of a product into a target geographical area in which the product is unavailable from an authorized or recognized distributor. The system can include: a set of seeker computing devices, each seeker computing device comprising a processing unit, a network communication unit, and a memory storing an application program, which when executed by the processing unit selectively configures the seeker computing device for (a) capturing and/or receiving in response to user input information corresponding to a product, including a set of images of the product, (b) generating a target product verification request corresponding to the product, the target product verification request comprising the set of images and information corresponding to the target geographical area, and (c) electronically communicating the target product verification request over an electronic network in response to user input; a product database storing product information including a product identifier and product status data with respect to the product's availability in the target geographical area; and a new product introduction system communicable with the set of seeker computing devices by way of the electronic network, the new product introduction system including a set of processing resources, a set of network communication resources, a set of memory resources, and a set of new product introduction program instructions stored in the set of memory resources, which when executed by the set of processing resources configures the new product introduction system for performing new product introduction operations that include: receiving from a first seeker computing device a first target product verification request corresponding to a first product and including a set of images of the first product and information corresponding to the target geographical area; processing the first target product verification request for determining whether the first product is available from an authorized or recognized distributor in the target geographical area; and automatically determining whether the first product satisfies an estimated popularity criterion with respect to the target geographical area.

The set of new product introduction program instructions, when executed by the set of processing resources, can configure the new product introduction system for processing the first target product verification request by: automatically extracting a first image of the first product from the first target product verification request; and automatically submitting the first image to a search engine or search service configured for performing image-based search and recognition operations.

The set of seeker computing devices can include a plurality of computing devices (e.g., tens, many tens, up to many hundreds, or thousands of seeker computing devices). The set of new product introduction program instructions, when executed by the set of processing resources, can configure the new product introduction system for performing new product identification operations including: designating the first product as a yet-to-be-identified product; receiving a plurality of product identification submissions corresponding to the yet-to-be-identified first product from the plurality of seeker computing devices, each product identification submission including a potential product name for the first product; determining a most frequently submitted potential product name for the first product based upon the plurality of product identification submissions; and selecting the most frequently submitted potential product name as the most likely or actual name of the first product. The set of new product introduction program instructions, when executed by the set of processing resources, can also configure the new product introduction system for performing new product identification operations further including: identifying a reference image corresponding to the first product; and posting the reference image of the first product to a product recognition/identification graphical user interface (GUI) provided by each of the plurality of seeker computing devices. Each seeker computing device within the plurality of seeker computing devices can be associated with a seeker identifier (ID). The set of new product introduction program instructions, when executed by the set of processing resources, can configure the new product introduction system for performing new product identification operations further including: determining a total number T of seeker IDs associated with the most frequently submitted potential product name; determining a set of k of seeker IDs associated with earliest product identification submissions within the plurality of product identification submissions that included the most frequently submitted potential product name, where k<T; and associating an electronic credit or award with each seeker ID within the set of k seeker IDs.

The set of new product introduction program instructions, when executed by the set of processing resources, can configure the new product introduction system for performing new product introduction operations further including determining whether the first product is available within the target geographical area by way of online sales of the first product for delivery or pickup in the target geographical area in the absence of an authorized or recognized distributor for the first product in the target geographical area.

When executed by the set of processing resources, the set of new product introduction instructions can configure the new product introduction system for performing new product introduction operations further including communicating over the electronic network first product availability information to one or more seeker computing devices within the set of seeker computing devices, wherein the first product availability information includes data corresponding to at least one business or at least one map location within the target geographical area from which the first product is available for purchase.

The set of new product introduction instructions, when executed by the set of processing resources, can configure the new product introduction system for automatically determining whether the first product satisfies an estimated popularity criterion with respect to the target geographical area by: maintaining a cumulative number or count of target product verification requests corresponding to the first product and the target geographical area received from seeker computing devices after receipt of the first target product verification request; and determining whether the cumulative number or count of target product verification requests corresponding to the first product and the target geographical area meets or exceeds a minimum estimated popularity threshold within a predetermined, selectable, or programmable monitoring period that temporally extends past the receipt of the first target product verification request.

The set of new product introduction instructions, when executed by the set of processing resources, can configure the new product introduction system for performing new product introduction operations further including: receiving rating data corresponding to the first product from a set of rating event computing devices at a product rating event at which the first product is presented; automatically generating rating statistics corresponding to the first product based upon the rating data; and automatically communicating the rating statistics over an electronic network to a plurality of computing devices external to or remote from the product rating event.

The set of new product introduction instructions, when executed by the set of processing resources, can configure the new product introduction system for performing new product introduction operations further including receiving and processing venture orders for importation of the first product into the target geographical area in the event that the first product is not available from an authorized or recognized distributor in the target geographical area, where each venture order identifies an investor having a presence in the target geographical area and includes an order quantity and a selling price objective for the first product (e.g., established by the investor).

The set of new product new product introduction instructions, when executed by the set of processing resources, can configure the new product introduction system for performing new product introduction operations further including receiving and processing online orders for the first product for delivery or pickup in the target geographical area in the absence of an authorized or recognized distributor for the first product in the target geographical area, after the importation of the first product into the target geographical area as a result of investors' venture orders.

When executed by the set of processing resources, the set of new product introduction program instructions can configure the new product introduction system for performing new product introduction operations further including: determining a distributable revenue amount corresponding an online order time period during which online orders for the first product for receipt or delivery in the target geographical area were received; and automatically apportioning the distributable revenue amount among the venture order investors. Automatically apportioning the distributable revenue amount among the venture order investors can include apportioning (a) costs or values corresponding to online sales of the first product, (b) administrative fees corresponding to the first product, and (c) online sales profits corresponding to the first product among investors in a manner correlated with first product quantities or first product selling price objectives in investor venture orders and an allocation of stock of the first product for online sales.

The set of new product new product introduction instructions, when executed by the set of processing resources, can configure the new product introduction system for performing new product introduction operations further including updating status data corresponding to the first product in the product database based upon whether the first product is (a) available from an authorized or recognized distributor in the target geographical area, (b) under consideration for importation into the target geographical area, (c) available in the absence of an authorized or recognized distributor in the target geographical area for receipt or delivery in the target geographical area (i) from venture order investors and/or (ii) by way of online orders.

### BRIEF DESCRIPTION OF THE DRAWINGS AND TABLES

FIG. 1 is a schematic illustration of a representative computer/communications network based system for product introduction and supply chain management in the absence of authorized/recognized distributors in one or more target geographical areas in accordance with an embodiment of the present disclosure.

FIG. 2 is a block diagram of a representative product introduction/supply chain management system or server in accordance with an embodiment of the present disclosure.

FIGS. 3A-3M are illustrations of a representative seeker mobile device on which a seeker mobile app executes, which provides a set of seeker graphical user interfaces (GUIs) in accordance with an embodiment of the present disclosure.

FIGS. 4A-4B show a flow diagram of a representative process for processing target product verification requests in accordance with an embodiment of the present disclosure.

FIG. 4C is a flow diagram of a representative process for receiving and processing product identification submissions in accordance with an embodiment of the present disclosure.

FIG. 5 is a flow diagram of a representative process for determining whether a candidate new product should be designated as an evaluation product in a given target geographical area in accordance with an embodiment of the present disclosure.

FIG. 6 is a flow diagram of a representative process for managing evaluation products and product rating events in accordance with an embodiment of the present disclosure.

FIG. 7 is a flow diagram of a representative process for managing venture orders and product importation directed to a target geographical area under consideration in accordance with an embodiment of the present disclosure.

FIG. 8 is a flow diagram of a representative process for managing online product orders or sales and venture order revenue/profit apportionment in accordance with an embodiment of the present disclosure.

FIG. 9 is a flow diagram of a representative process for managing new/introduced product reordering in a target geographical area under consideration in accordance with an embodiment of the present disclosure.

Table 1 illustrates a set of foundational product parameters for a representative new/introduced product for a target geographical area under consideration in accordance with an embodiment of the present disclosure.

Table 2 illustrates a representative set of venture order parameters that are maintained for the representative new/introduced product of Table 1, corresponding to venture orders received from testing and possibly trading members, which can be collectively referred to as “venture investors” or “investors.”

Table 3 illustrates a representative set of online orders in stock keeping units (SKU) for the representative new/introduced product of Tables 1 and 2, which were received between successive venture reward settlement periods or dates from members designated as buyers, who can be collectively referred to as “customers.”

Table 4 illustrates a representative manner of apportioning online sales profits among testing and trading members who participated in the representative aggregate venture order of Table 2, in accordance with an embodiment of the present disclosure.

### DETAILED DESCRIPTION

Examples of embodiments in accordance with the present disclosure described herein are nonlimiting representative examples that are provided for purpose of aiding clarity and understanding. Additional or other embodiments or embodiment details not expressly described herein that conform to the fundamental structural and/or functional/operational principles of embodiments described herein fall within the scope of the present disclosure.

In the present disclosure, the depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated. Additionally, unless explicitly stated otherwise, in the description herein, the use of the term “approximately” or “substantially” with respect to an object, element, structure, or parameter is taken to mean within a range of +/−20%, +/−10%, or +/−5% relative to the entirety of the object, element, structure, or parameter, respectively. Similarly, the recitation of particular numerical values or value ranges is taken to be a recitation of particular approximate numerical values or approximate value ranges (e.g., within +/−20%, or +/−10%, or +/−5%).

As used herein, the term “set” corresponds to or is defined as a non-empty finite organization of elements that mathematically exhibits a cardinality of at least 1 (i.e., a set as defined herein can correspond to a singlet or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a system, an apparatus, a device, a structure, a structural feature, an object, a material, a substance, a process, a physical parameter, or a value, depending upon the type of set under consideration.

### Overview

Embodiments in accordance with the present disclosure are directed to computer network based systems and services/processes for (a) introducing new (e.g., not presently available) products into a target geographical area that lacks authorized or recognized distributors for the new products; and (b) providing particular types of new product supply chain management services for such new products within the target geographical area. In multiple embodiments, access to a new product introduction/supply chain management system and the services provided thereby is granted to different categorical types of registered users or members on a selective basis in accordance with a user role or membership type. In several embodiments, at least some membership types correspond to or represent business entities. A new product introduction/supply chain management system in accordance with an embodiment of the present disclosure can thus facilitate or enable business-to-business (B2B) transactions between sources/suppliers (e.g., manufacturers) of new products outside of a target geographical area for which authorized/recognized new product distributors are not identified or are inactive, and business entities within the target geographical area that intend to sell the new products therein. Furthermore, a new product introduction/supply chain management system in accordance with an embodiment of the present disclosure can combine or pool venture orders submitted by investors (e.g., associated with the aforementioned business entities) and which are directed to a new product in a target geographical area for which an authorized or recognized distributor does not yet exist, such that more favorable costing can be obtained from a product source (e.g., a manufacturer or distributor) external to this target geographical area (e.g., relative to minimum order volume constraints imposed by the external product source).

A new product introduction/supply chain management system in accordance with an embodiment of the present disclosure is configured for facilitating or enabling at least some the following:
(1) providing one or more product databases that store product images, product descriptions, and product manufacturer information;
(2) for products identified in the product database(s), selectively maintaining product status information relative to one or more target geographical areas, where for each target geographical area the product status information includes product availability/status designations, which can include, for instance, (a) “candidate new”; (b) “evaluation”/“under evaluation”; (c) “insufficient interest”/“not ready for introduction”; (d) “evaluated”; (e) “ordered for introduction”; (f) “new/introduced”; and/or (g) “already existing”;
(3) providing and/or communicating with a set of program instructions such as a browser executable application (e.g., a mobile/portable computing device application, such as a downloadable app for a mobile telephone/smartphone) by which members defined as “product seekers” or “seekers” can generate and submit target product verification requests for target products they believe are not yet available, but would like to be available, within a target geographical area designated as their preferred, primary, or home geographical area, where each target product verification request includes a set of images of a target product;
(4) receiving and processing target product verification requests submitted by seekers by way of the browser executable application;
(5) identifying a product corresponding to or shown within an image of a target product verification request, which can include determining or identifying a product brand name and possibly a product manufacturer;
(6) determining whether a target product corresponding to or shown within an image of a target product verification request is (a) presently unavailable from an authorized or recognized distributor in the target geographical area under consideration, and hence can qualify as a candidate new product to be considered for introduction into the target geographical area, or (b) already available from an authorized or recognized distributor in the target geographical area, and hence is an already existing product in the target geographical area;
(7) providing or communicating product availability information or notifications corresponding to an already existing product to seekers to indicate business locations at which the already existing product is available within the target geographical area in the event that a target product verification request corresponds to an already existing product rather than a candidate new product for the target geographical area;
(8) estimating the potential popularity of a candidate new product in the target geographical area, and designating the candidate new product as under evaluation if its potential popularity meets or exceeds one or more potential popularity criteria, such as a minimum estimated popularity threshold level, or designating the candidate new product as insufficient interest/not ready for introduction if its potential popularity does not satisfy such potential popularity criteria;
(9) obtaining actual samples of under evaluation products for the target geographical area from product manufacturers or distributors/retailers outside of the target geographical area;
(10) determining order parameters and estimated costs for ordering under evaluation products, including minimum order quantity and shipping, handling, duties, taxes, storage, administrative, and/or other costs for introducing an under evaluation product to the target geographical area;
(11) during a product testing/rating/evaluation event held within the target geographical area for members defined as “testing members” or “testers,” receiving and automatically processing product rating information for samples of under evaluation products by way of a browser executable application (e.g., a mobile/portable computing device application, such as a smartphone or tablet computer app);
(12) designating products for which product rating information has been submitted and processed as evaluated products;
(13) during and after the product rating event, communicating/distributing estimated ordering costs and product rating results for evaluated products to testing members as well as other members defined as “trading members” or “traders” associated with the target geographical area;
(14) for a given period of time after the product rating event, receiving, consolidating, and managing venture orders for evaluated products from testing members and trading members based upon product rating results, where each venture order corresponds to a given evaluated product, and specifies for each testing member and trading member an order quantity and possibly an expected selling price for the evaluated product;
(15) determining actual order costs for evaluated products in venture orders, based upon communication with (a) product sources such as manufacturers or distributors/retailers outside of the target geographical area, and (b) product shipping services, and updating venture order information based upon such actual order costs;
(16) receiving and processing payments from tasting members and trading members for venture orders;
(17) placing orders for evaluated products corresponding to venture orders from the appropriate product sources;
(18) receiving product shipments corresponding to venture orders at one or more local storage/warehouse facilities within the target geographical area;
(19) provided that payment for evaluated products has been received from testing members and trading members in accordance with their venture orders, designating such paid-for evaluated products as new/introduced products;
(20) managing local storage/warehouse inventories of new/introduced products within the target geographical area;
(21) selectively providing or delivering new/introduced products to locations (e.g., business locations) associated with testing members and trading members within the target geographical area in accordance with their venture orders;
(22) determining an online price for online sales of new/introduced products;
(23) selling new/introduced products online to members designated or defined as “buyers,” as well as any testing members and trading members who submit online orders for new/introduced products;
(24) automatically allocating profits/proceeds from online sales of new/introduced products within the target geographical area to testing members and trading members based upon one or more types of relative weightings of new/introduced products among testing members and trading members in a venture order;
(25) automatically adjusting local storage facility/warehouse inventory balances corresponding to testing members and trading members for online purchases of new/introduced products based upon the aforementioned relative weightings;
(26) providing or delivering new/introduced products to online purchasers within the target geographical area;
(27) rating/ranking, and potentially compensating (e.g., on a commission basis), product seekers based upon (a) their ability to successfully identify new/introduced products for the target geographical area, (b) the number of venture orders for new/introduced products with which the seeker is associated, and/or (c) online sales of new/introduced products with which the seeker is associated;
(28) receiving, processing, and fulfilling subsequent or replenishment venture orders for new/introduced products within the target geographical area;
(29) determining whether an authorized/recognized distributor within the target geographical area has recently been established for any new/introduced product
(30) designating a new/introduced product as “existing” once an authorized/recognized distributor for the new/introduced product is operating in the target geographical area; and
(31) automatically transferring any pending venture orders for products recently designated as existing to an authorized/recognized distributor in the target geographical area once the authorized/recognized distributor is operating therein.

An individual having ordinary skill in the relevant art will understand that the nomenclature used herein with respect to the designation of a given product under consideration as a target product, an existing product, a candidate new product, an evaluation product, or a new/introduced product with respect to a target geographical area under consideration can be interpreted as a matter of semantics. More particularly, a product under consideration can be associated with or assigned a particular designation in accordance with this or a similar nomenclature based upon the determination of a categorical product status at particular times and/or under predetermined circumstances with respect to the potential or actual introduction/importation of the product into the target geographical area under consideration. For instance, a first product can be initially designated as a target product in response to a first target product verification request corresponding to the first product for the target geographical area under consideration. Upon determination or verification that the first product is already available from an authorized/recognized distributor in the target geographical area, the first product can be designated as an existing product. Alternatively, upon determination or verification that the first product is not yet available from an authorized/recognized distributor in the target geographical area, the first product can be designated as a candidate new product. Once the first product has selected for presentation at a product rating event, the first product can be designated as an evaluation product. After a first shipment of the first product has been received in the target geographical area under consideration as a result of venture orders directed to the first product in this target geographical area, the first product can be designated as a new/introduced product.

In addition to the foregoing, an individual having ordinary skill in the relevant art will understand that the nomenclature used herein with respect to the categorical types of individuals or businesses that communicate or interact with the new product introduction/supply chain management system can also be interpreted as a matter of semantics. Thus, such individuals or businesses can be categorized or identified using terms other than “seekers,” “testers”/“testing members,” “traders”/“trading members,” and “buyers” in accordance with embodiments of the present disclosure.

Embodiments in accordance with the present disclosure can be particularly well-suited to the introduction, sale, and distribution of one or more types of consumer goods, and in particular, Fast Moving Consumer Goods (FMCG), in geographic regions or areas (e.g., a country or a portion thereof, such as a multi-state region, a state, or a city) in which authorized/recognized distributors for the FMCG are not yet defined, established, or in operation. For purposes of simplicity, brevity, and to aid understanding in the description that follows, target products and hence new/introduced products can include or be food/beverage products. However, an individual having ordinary skill in the relevant art will understand that target products and new/introduced products need not be limited to food/beverage products, but can additionally or alternatively include other types of products, for instance, health/beauty products (e.g., health supplements or cosmetics), toys/games, and/or other types of consumer goods.

To further aid simplicity, brevity, and understanding, certain representative embodiments of the present disclosure in the description that follows consider the introduction of and supply chain management for products for which authorized/recognized distributors are not yet defined, established, or in operation in a single target geographical area, namely, the country of Singapore. Notwithstanding, an individual having ordinary skill in the relevant art will recognize that embodiments in accordance with the present disclosure can consider or manage the introduction of and supply chain management for products in other and/or additional target geographical areas (e.g., multiple countries) in which authorized/recognized distributors for such products are not yet defined, established, or in operation.

### Representative System Architecture and System Functionality

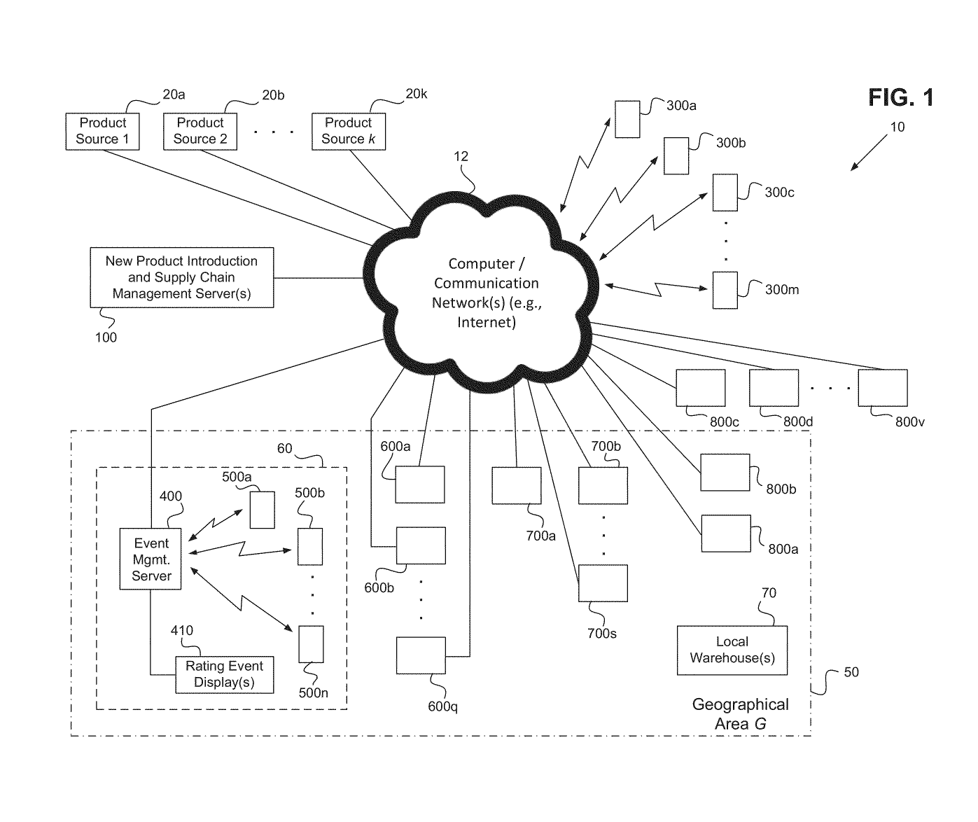

FIG. 1 is a schematic illustration of a representative computer/communications network based system 10 for product introduction and supply chain management in the absence of authorized/recognized distributors in one or more target geographical areas in accordance with an embodiment of the present disclosure. In an embodiment, a product introduction/supply chain management system 10 includes at least one product introduction/supply chain management system or server 100 configured for communication with various computing/electronic systems and/or devices that serve particular functions or roles relative to product introduction and/or supply chain management operations, services, or processes for multiple types of members that have registered with the product introduction/supply chain management server 100. In various embodiments, such types of members can include seekers, testing members, trading members, and buyers. Other embodiments can provide product introduction and/or supply chain management operations, services, or processes to additional or other types of users or members.

More particularly, the product introduction/supply chain management server 100 is configured for communication with a plurality of seeker computing devices 300a-m, which can include desktop computers and/or portable/handheld devices such as laptop computers, tablet computers, mobile phones/smartphones, phablet computers (i.e., combined or hybrid mobile phone/tablet computers) or other devices (e.g., wearable computing/communication devices) configured for capturing, storing, and/or communicating images of target products. Thus, each seeker computing device 300a-m includes a processing unit, a memory, a network communication unit, a display device, and one or more user input devices/interfaces, in a manner readily understood by an individual having ordinary skill in the relevant art.

In various embodiments, communication between the new product introduction/supply chain management server 100 and seeker computing devices 300a-m includes receiving and processing target product verification requests from seeker computing devices 300a-m. A target product verification request can include a seeker identifier (ID) and possibly a target geographical area ID corresponding to the seeker's primary or home geographical area 50; a time and date stamp; possibly a location identifier such as an IP address and/or a set of geospatial coordinates (e.g., global positioning satellite (GPS) coordinates); and one or more images showing at least portions of a target product, where the image(s) can include time and date stamps. Product images should generally or typically include or show a complete, nearly complete, or generally complete view of the target product, including product name and labeling/packaging, and possibly other information such as an image of a Quick Response (QR) code on target product labeling/packaging. In various embodiments, the new product introduction/supply chain management server 100 maintains a history of target product verification requests submitted by each seeker (e.g., a history of target product verification requests corresponding to each seeker ID).

The product introduction/supply chain management server 100 is further configured for processing each target product verification request received from a seeker computing device 300a-m to determine if the target product corresponding to the request (a) has previously been or is currently being considered by the server 100 as a result of an earlier target product verification request received from a “first to submit” or “discovering” seeker; and (b) is already available from an authorized/recognized distributor that serves the seeker's primary/home geographical area 50. Target product verification request processing can involve manual, semi-automated, or automated operations, as further detailed below. In association with or as a result of processing a target product verification request, the product introduction/supply chain management server 100 categorizes the target product corresponding to the request as a candidate new product if the product identified in the target product verification request has not already been submitted by a first to submit/discovering seeker, and no corresponding authorized/recognized distributor for this product currently serves the target geographical area 50 under consideration. If an authorized/recognized distributor for this product currently serves this target geographical area 50, the product introduction/supply chain management server 100 categorizes or designates the product as an already existing product in the target geographical area 50.

Once the product introduction/supply chain management server 100 has designated a target product as a candidate new product, the product introduction/supply chain management server 100 tracks or monitors for a limited period of time (e.g., 2-8 weeks, or a shorter or longer time period) the number of target product verification requests corresponding to the candidate new product that are received from all seekers associated with the target geographic area 50 currently under consideration, other than the first to submit seeker. In various embodiments, such target product verification request tracking/monitoring enables the product introduction/supply chain management server 100 to estimate the candidate new product's popularity in the target geographic area 50. If the number of target product verification requests received from all seekers associated with the first to submit/discovering seeker's primary/home geographical area 50 within the tracking time period meets or exceeds a minimum request count threshold, the product introduction/supply chain management server 100 can designate the candidate new product as an under evaluation product for this target geographical area 50. The tracking time period and/or the minimum request count threshold can be selectable, adjustable, or programmably specified, for instance, based upon the type of candidate new product and/or other factors such as population/demographic data or estimated pricing for the candidate new product in the target geographical area 50 under consideration.

During the tracking period, the product introduction/supply chain management server 100 can provide information accessible to seekers that indicates a current estimated popularity level for a candidate new product, for instance, a cumulative number of target product verification requests corresponding to the candidate new product that have been received since the first target product verification request therefor was submitted by the first to submit seeker. If a candidate new product fails to meet the minimum request count threshold within the tracking time period, the product introduction/supply chain management server 100 can designate the candidate new product as having insufficient interest or not ready for introduction in the target geographical area 50 under consideration. This candidate new product can possibly be considered for introduction in the target geographical area 50 at a future time, for instance, after a predetermined number of months (e.g., 3-6 months, or a shorter or longer time period) if additional target product verification requests corresponding to the candidate new product are received by or after that future time.

The product introduction/supply chain management server 100 is also configured for communication with other types of computing/electronic systems or devices, including at least one rating event management system 400 and/or a plurality of portable/handheld rating event computing devices 500a-n located within the target geographical area 50 under consideration. A product rating event can be held at a product rating site or facility 60 within the target geographical area 50, such as a convention/conference center, a hotel facility, or a testing member's business or home location. During a product rating event, attending testing members can sample or test evaluation products; and submit corresponding product rating data/evaluations/feedback by way of their rating event computing devices 500a-n. Rating event computing devices 500a-n can include one or more of mobile telephones/smartphones; tablet computers; phablets (e.g., smartphone—tablet hybrids); and laptop computers configured to communicate with the rating event management system 400. The rating event management system 400 can be a desktop or laptop computer system configured for communication with (a) the product introduction/supply chain management server 100, (b) rating event computing devices 500a-n, and (c) a set of main or central rating event display devices 410. The rating event display device(s) 410 can include one or more devices capable of displaying new product information and rating/feedback information, such as rating statistics or rating indicators (e.g., graphics/icons) corresponding thereto based upon product testing/evaluation/feedback received from testing members by way of their testing member computing devices 600a-q.

During a product rating event, the product introduction/supply chain management server 100 can communicate estimated order costs for each product at the product rating event to the rating event management server 400, which can further communicate such estimated costs for these under evaluation products to the rating event computing devices 500a-n and/or the set of rating event display devices 410.

In several embodiments, the product introduction/supply chain management server 100 is configured for receiving product rating data and any feedback associated therewith from the rating event management system 400; generating product rating statistics and possibly product rating indicators associated with such rating data and feedback; and communicating the rating statistics and/or rating indicators to the rating event management system 400. In certain embodiments, the rating event management system 400 can directly generate product rating statistics and/or rating indicators, which it can communicate to the product introduction/supply chain management server 100. The rating event management system 400 can present product rating statistics and/or rating indicators on the set of rating event display devices 410, such that testing members can view rating statistics/indicators during a product evaluation event, for instance, on a dynamic basis in association with testing member submission of product rating data. The rating event management system 400 can additionally or alternatively communicate product rating statistics or rating indicators to the rating event computing devices 500a-n. In various embodiments, testing members can place venture orders for evaluated products during a product rating event by way of their rating event computing devices 500a-n (e.g., in association with a venture order application program, which can be a web app/mobile device app).

The product introduction/supply chain management server 100 is also configured for communication with testing member computing devices 600a-q as well as trading member computing devices 700a-s that are external to or remote from product rating events, by which testing members and trading members, respectively, can access product rating data and estimated product cost information for evaluated products; place or update venture orders for such products; check venture order status; and/or perform other operations. Furthermore, the new product introduction/supply chain management server 100 can be configured for communication with other categorical types of computing/electronic systems or devices 800a-v, which can be internal or external to the target geographical area 50 under consideration. Such other types of systems/devices 800a-v can include member registration systems/devices by which an individual can register as a seeker, a tester, a trader, or a buyer; and/or online order or purchase systems/devices by which testers, traders, or buyers can order products introduced into the target geographical area 50, and select product pickup or a product delivery mode within the target geographical area 50 for such ordered products.

In at least some embodiments, the product introduction/supply chain management server 100 is also configured for automatically determining and apportioning tester/testing member and trader/trading member net revenue or profits corresponding to online sales of new products, as further detailed below.

In various embodiments, at least some types of member services provided by the product introduction/supply chain management server 100 are fee based (e.g., subscription based). For instance, membership for seekers can be free; whereas membership for testers can be charged at a highest or premium/platinum membership rate, membership for traders can be charged at a lower or gold membership rate; and membership for buyers can be charged at a lowest or standard rate. Membership fees can be charged on a monthly, quarterly, annual, or other basis.

While particular types of computing/electronic systems or devices in FIG. 1 are identified as categorically distinct or separate from each other, an individual having ordinary skill in the relevant art will recognize that a single electronic/computing system or device can be configured to support or enable multiple types of new product introduction/supply chain management roles, functions, processes, or services in accordance with an embodiment of the present disclosure. For instance, a rating event computing device 500 and a testing member computing device 600 can be the same device, which is configured for supporting or providing or performing different types of new product introduction/supply chain management operations depending upon device usage context and/or location.

In addition to the foregoing, the system 10 can also be configured for communication with one or more computing systems, devices, or interfaces associated with product sources 20a-k, such as web sites and/or product ordering systems associated with product manufacturers, or product distributors and/or retailers located outside of a target geographical area 50 under consideration. New/introduced products corresponding to such product sources 20a-k can be shipped into the target geographical area 50 and stored in one or more local warehouses 70 within the target geographical area 50.

While FIG. 1 identifies a single target geographical area 50, embodiments in accordance with the present disclosure can be configured for introducing products and managing aspects of supply chain distribution for products in multiple target geographical areas 50, in a manner readily understood by one having ordinary skill in the relevant art. For instance, an embodiment in accordance with the present disclosure can include a single product introduction/supply chain management system 10 associated with multiple target geographical areas 50, or multiple product introduction/supply chain management systems 10, each of which is associated with at least one target geographical area 50.

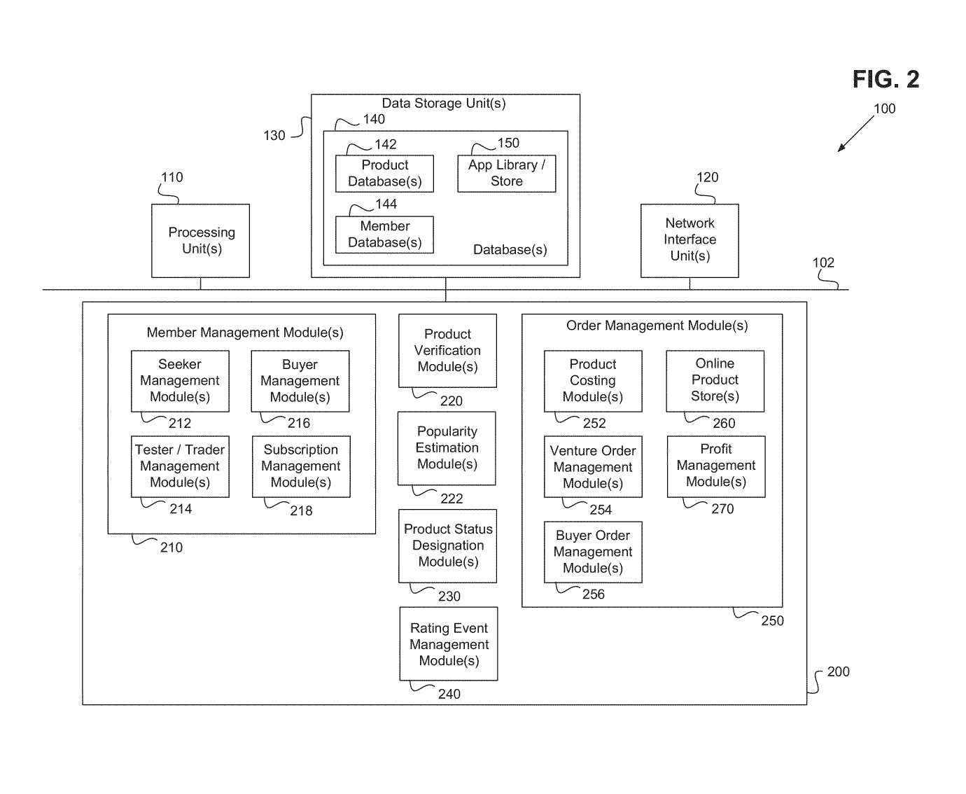

FIG. 2 is a block diagram of a representative product introduction/supply chain management system or server 100 in accordance with an embodiment of the present disclosure. In an embodiment, the new product introduction/supply chain management server 100 includes at least one processing unit 110; at least one network interface unit 120; and a set of local and/or remote data storage systems, servers, devices, or units 130, in which a number of databases 140 reside, including at least one product database 142 and one or more member databases 144. The product database 142 can store multiple types of product information or data, such as images, product names, and product source/origin data corresponding to target products, under evaluation products, introduced products, and already existing products, as well as associated product status data with respect to one or more target geographical areas 50. An application library/app store 150 can be associated with or reside in the database(s) 140, such that mobile apps corresponding to seekers, testers, traders, and buyers are available for download therefrom. Such mobile apps can additionally or alternatively be downloadable from one or more other app stores, in a manner readily understood by those having ordinary skill in the relevant art.

The server 100 further includes a memory 200 in which various types of modules reside for facilitating or enabling product introduction/supply chain management functions, operations, processes, or services in accordance with an embodiment of the present disclosure, as further detailed below. In a number of embodiments, such modules include program instruction sets that are executable by the processing unit(s) 110 for supporting or providing product introduction/supply chain management functions, operations, processes, or services. The server 100 additionally includes one or more common signal/data transfer pathways 102, such as a set of buses, by which information transfer between particular server elements occurs, in a manner readily understood by one having ordinary skill in the relevant art.

In an embodiment, the memory 200 includes a set of member management modules 210 configured for managing member registration, member log-in/log-out procedures, member subscriptions, and other member related services. Such member management modules 210 include each of a seeker management module 212; a tester/trader management module 214; a buyer management module 216; and a member subscription module 218. The memory 200 also includes a target product verification module 220; a product popularity estimation module 222; a product status designation module 230; and a rating event management module 240. The memory 200 further includes a set of product order management modules 250, such as a product costing module 252; a venture order management module 254; a buyer order management module 256; an online product store 260, and a profit management module 270.

While particular elements/modules of the product introduction/supply chain management server 100 are illustrated as residing within a single system or server, an individual having ordinary skill in the relevant art will understand that one or more elements/modules can reside in or be distributed across multiple systems or servers, depending upon embodiment details. Furthermore, an individual having ordinary skill in the relevant art will understand that portions of the new product introduction/supply chain management server 100 that are directed to performing a particular categorical type of function, operation, process, or service can be referred to or implemented as a system or server configured for performing that type of function, operation, process, or service. For instance, portions of the new product introduction/supply chain management server 100 that are configured for processing target product verification requests can be referred to or implemented as a target product verification request processing system. Analogously, portions of the new product introduction/supply chain management server 100 that are configured for processing venture orders can be referred to or implemented as a venture order processing system; and portions of the new product introduction/supply chain management server 100 that are configured for managing online purchases of new/introduced products can be referred to or implemented as an online purchase management system.

### Representative Aspects of Member Registration

The subscription management module 218 can provide and manage subscription services by which an individual can register with the system 10 as a taster, a trader, a buyer, or a seeker. The subscription management module 218 can charge and process the appropriate subscription fees for fee-based membership types, such as tasters, traders, and buyers, for instance, on a one time or recurring basis. Upon successful member registration, the subscription management module 218 can store member details (e.g., member name, user ID, e-mail address, telephone number, primary/home geographical area 50, etc. . . . ) in the member database 144. In general, any or essentially any individual can register as a seeker. In a number of embodiments, a member registered as a seeker can additionally register as another type of member, such as a taster, trader, or buyer.

### Representative Aspects of Seeker GUIs and Seeker Interaction Therewith

As indicated above, any member designated as a seeker can submit target product verification requests to the product introduction/supply chain management server 100, such as by way of a browser based application. In an embodiment, a seeker can submit target product verification requests to the product introduction/supply chain management server 100 by way of a mobile app configured for execution on a mobile device (e.g., mobile phone/smartphone) corresponding to the seeker.

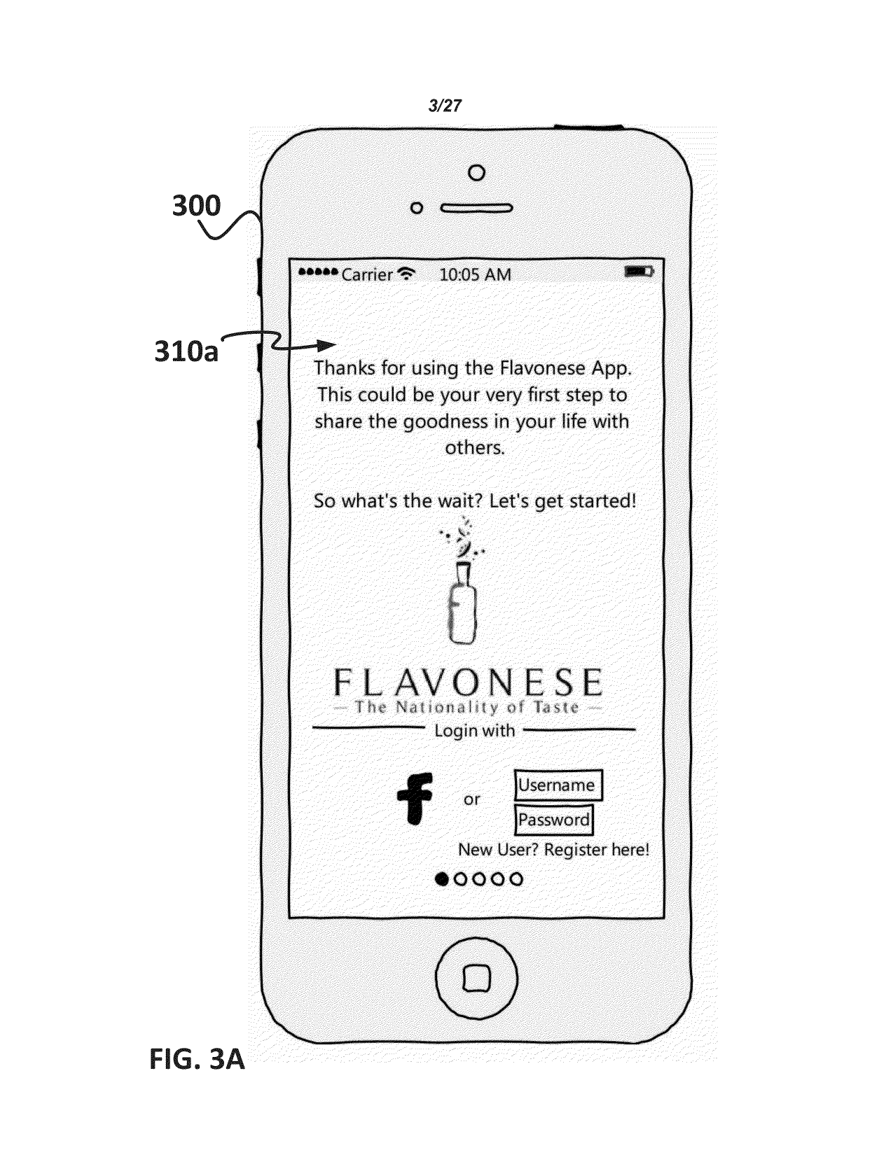

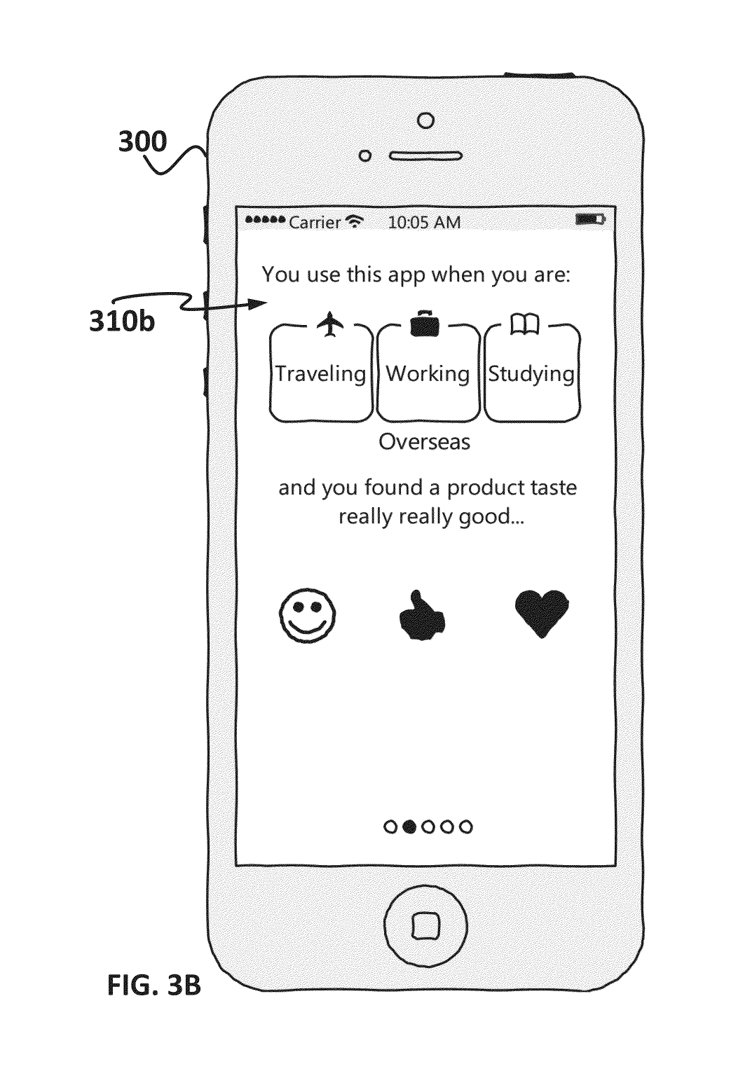

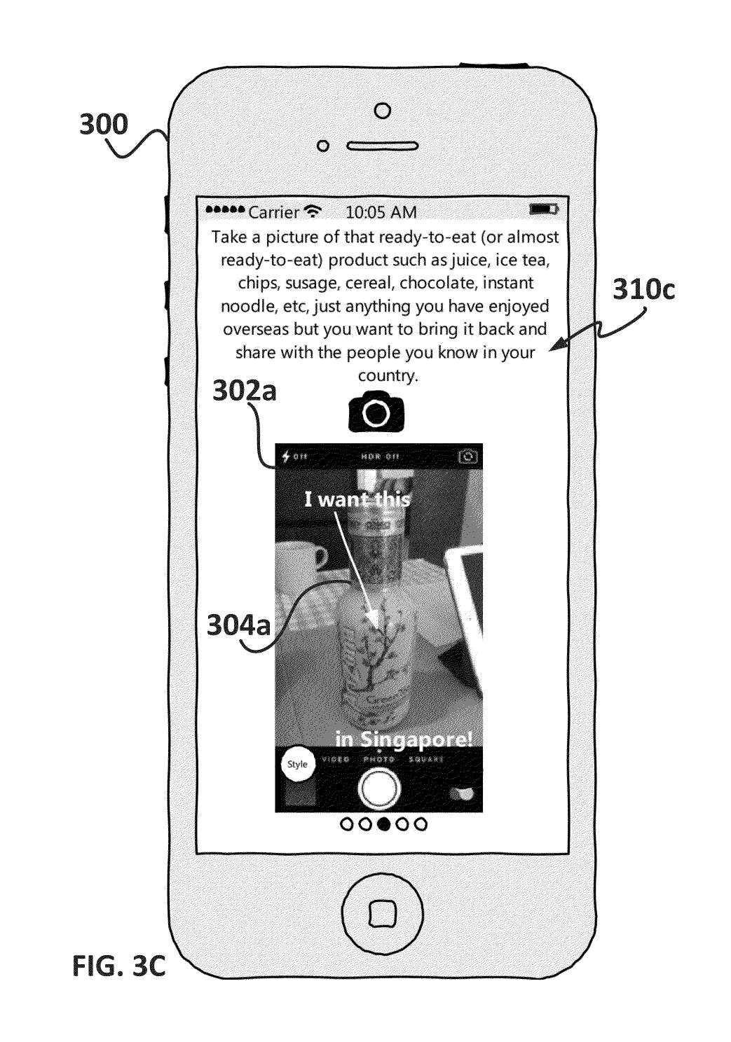

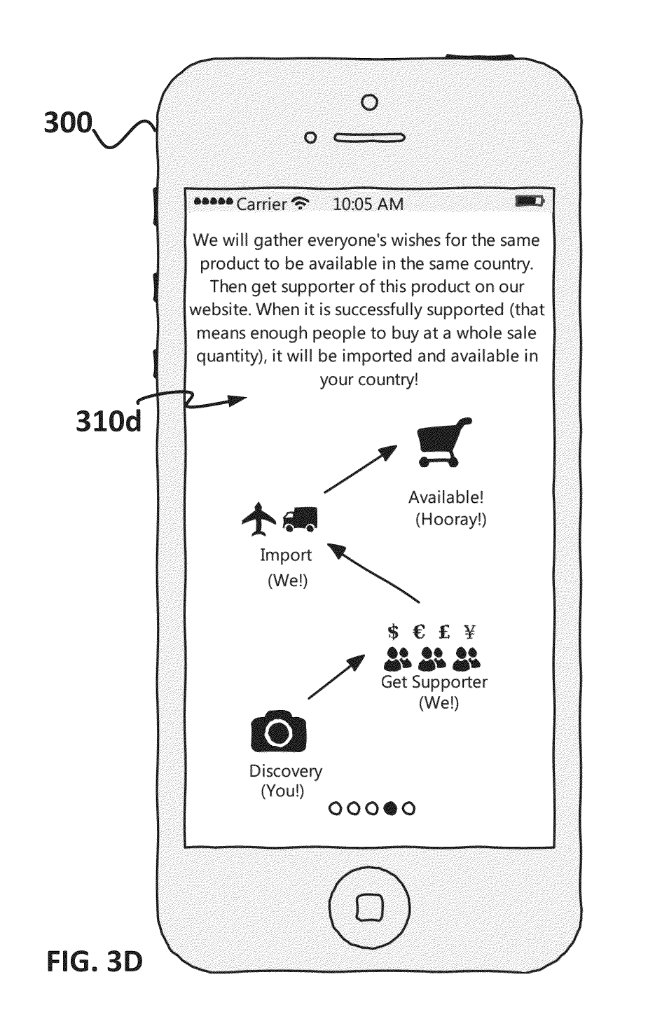

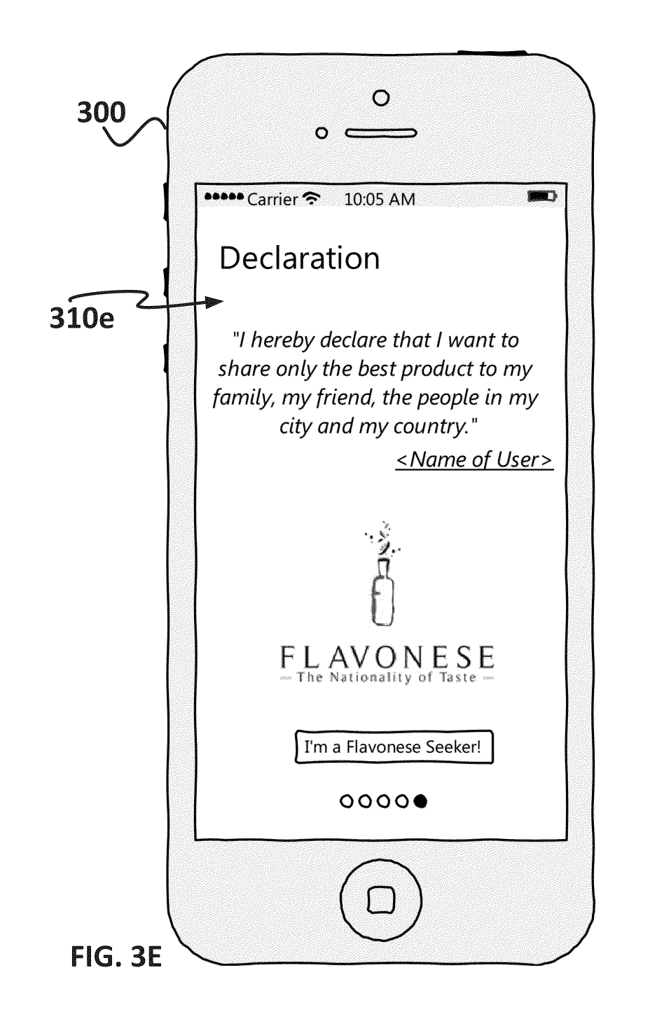

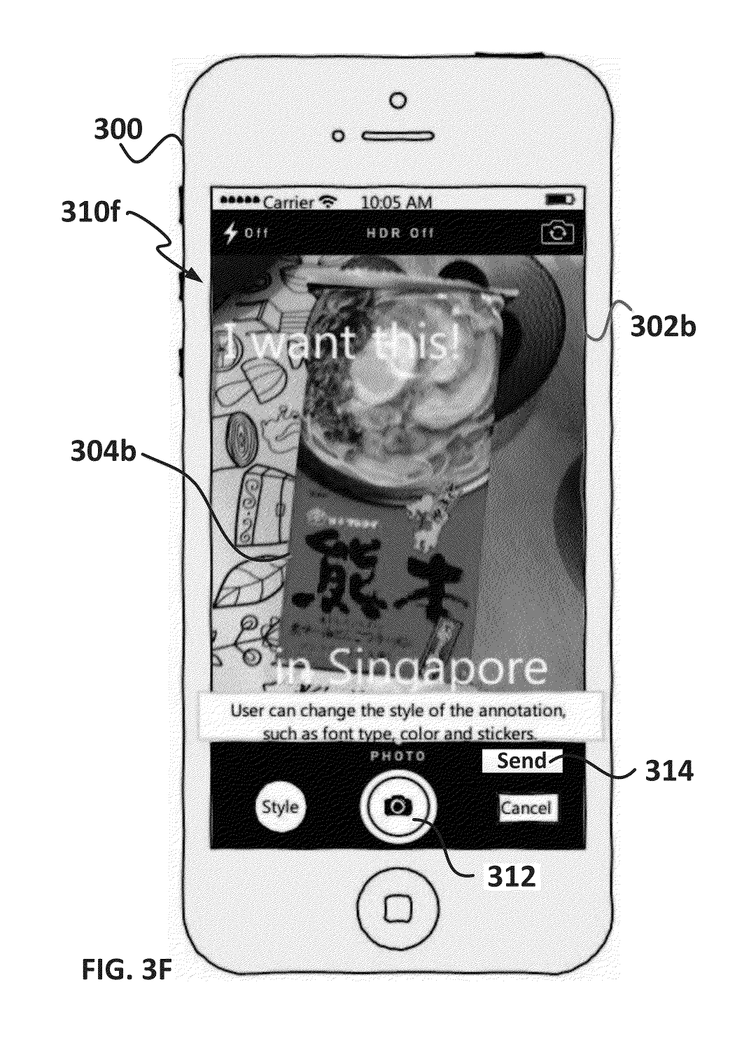

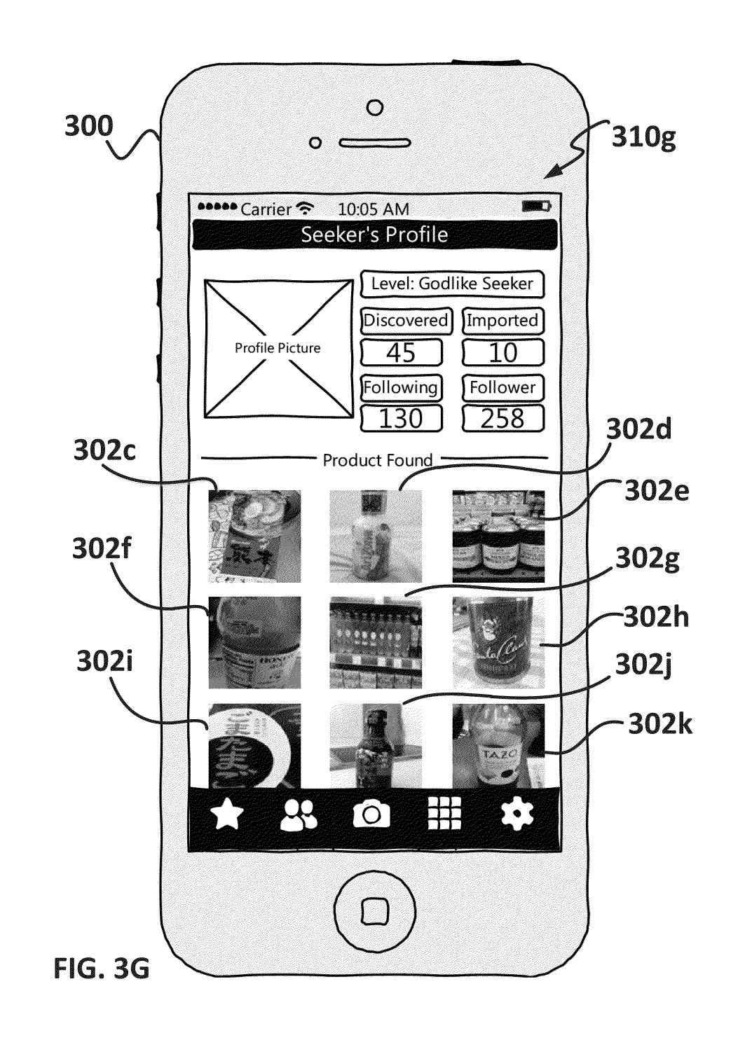

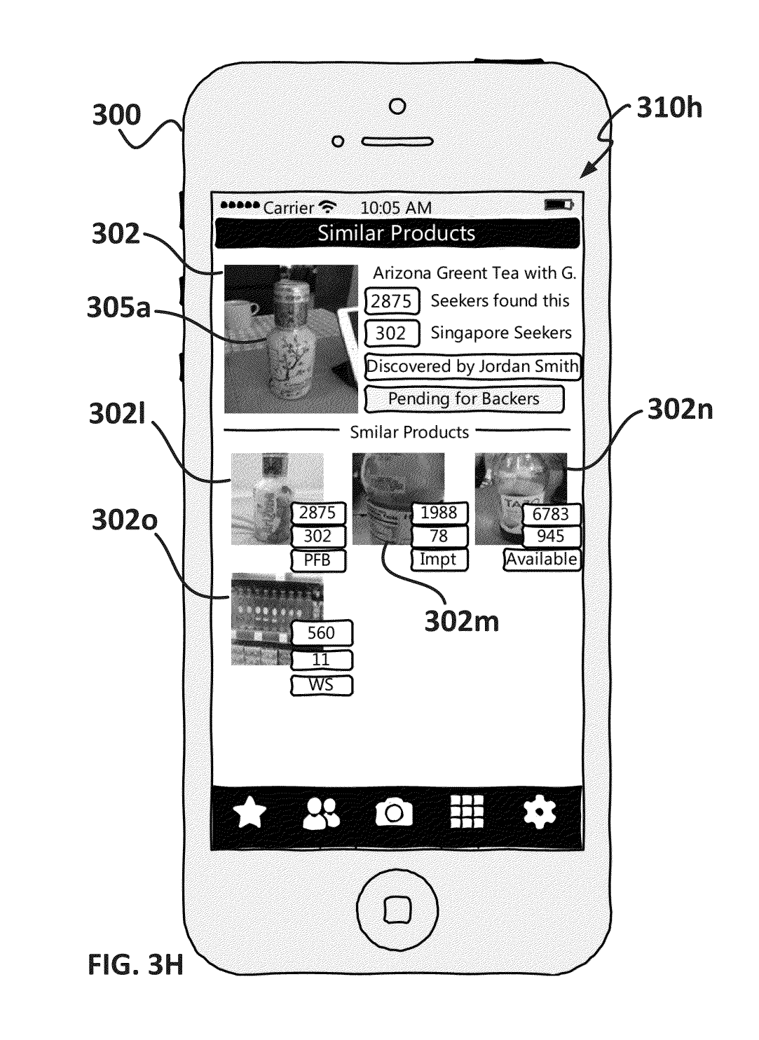

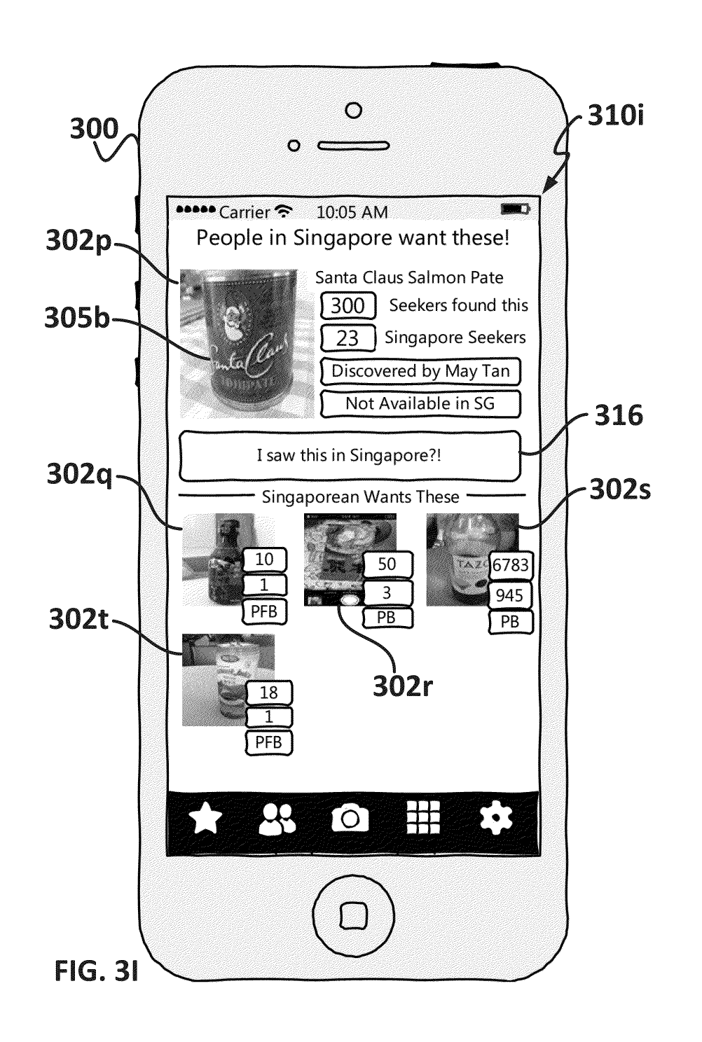

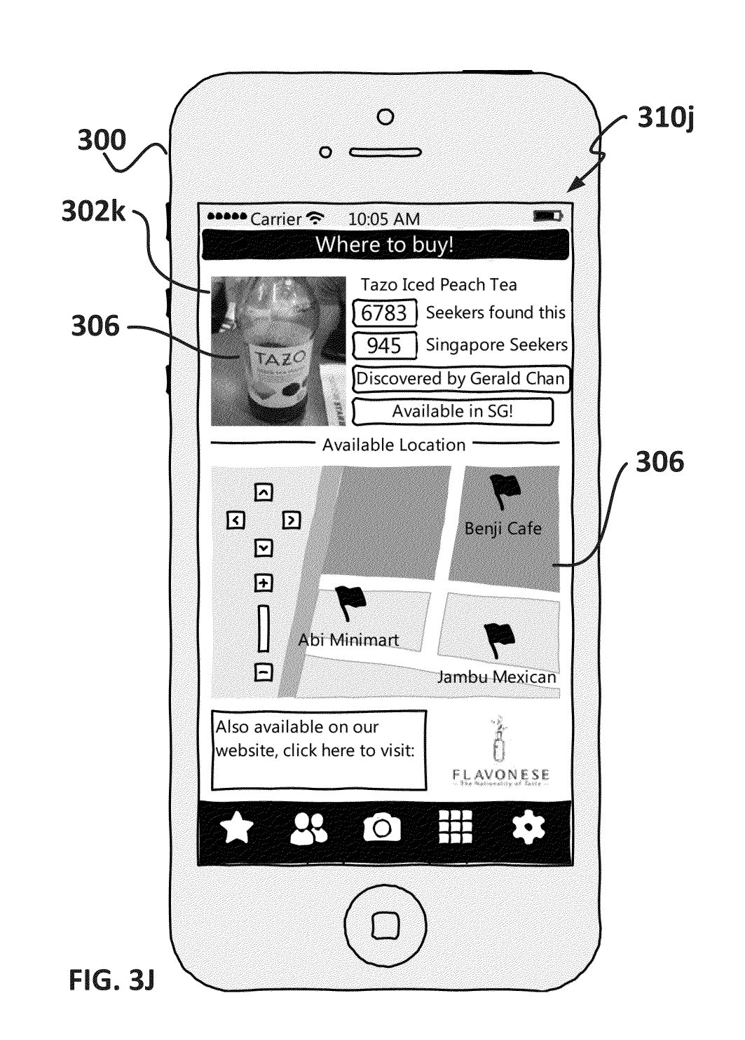

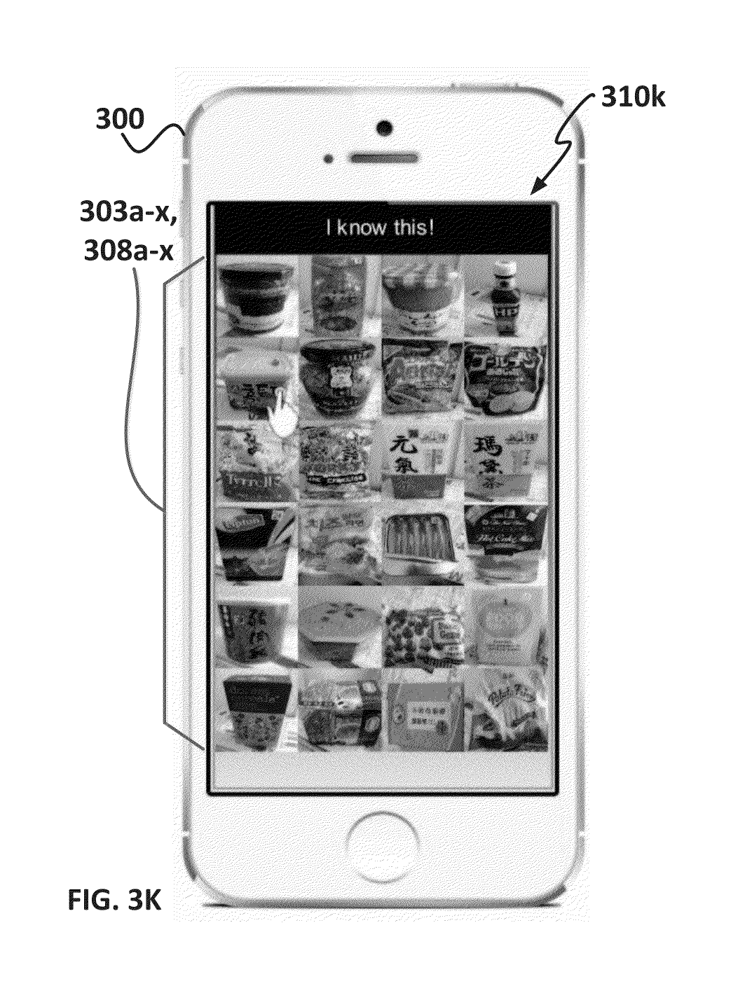

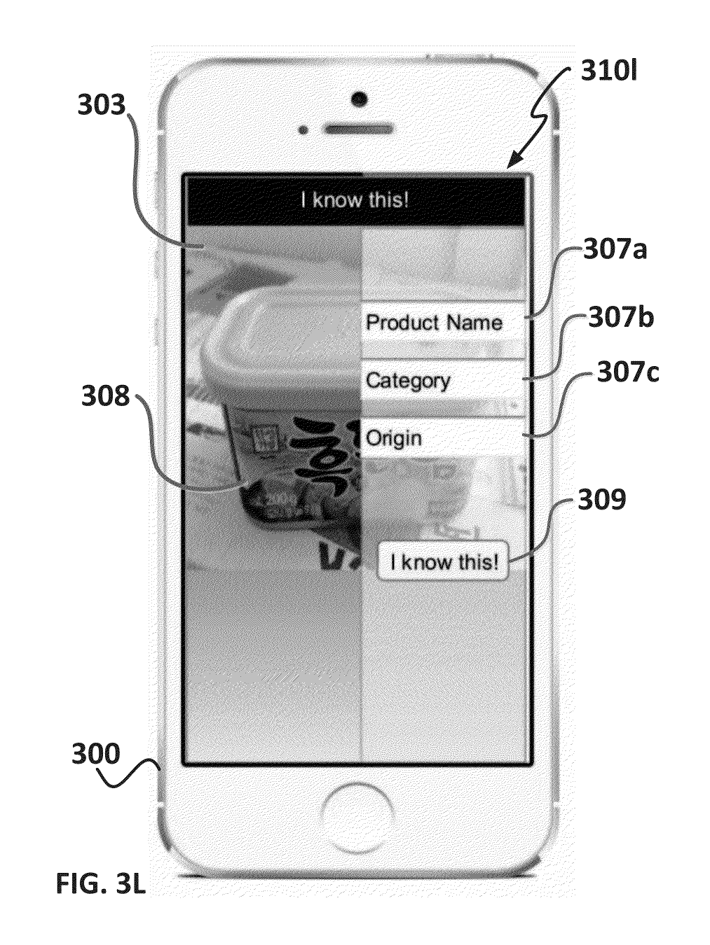

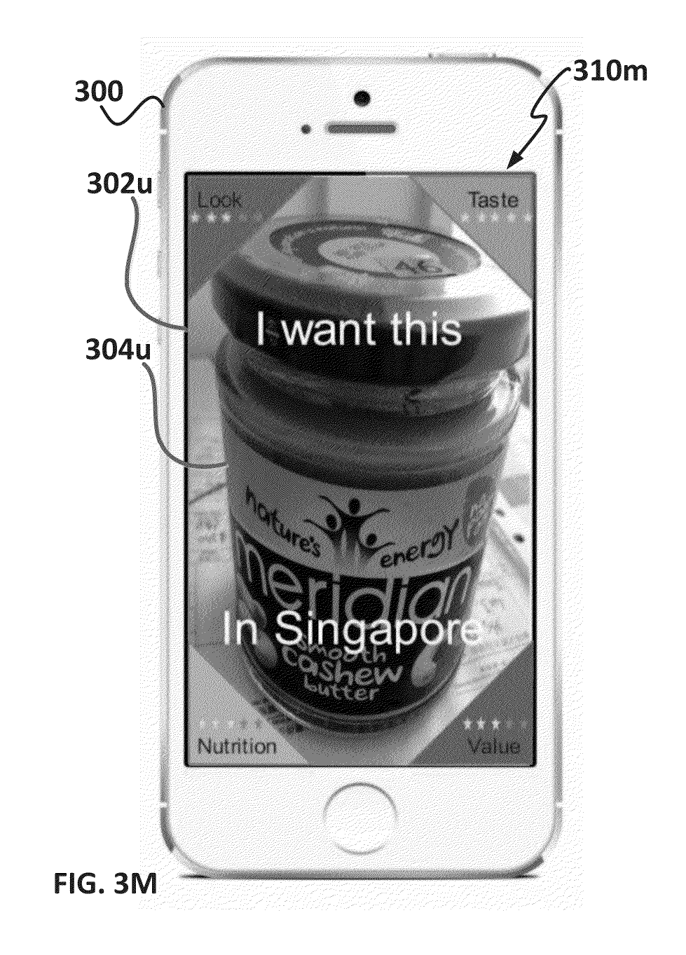

FIGS. 3A-3M are illustrations of a representative seeker mobile device 300 on which a seeker mobile app executes, which provides a set of seeker graphical user interfaces (GUIs) 310a-m in accordance with an embodiment of the present disclosure. In an embodiment, an introduction/tutorial GUI 310a-e can present introductory and tutorial information to the seeker, for instance, in a manner indicated in FIGS. 3A-3E. Tutorial information can include instructions directing the seeker to take one or more pictures/capture one or more images 302 of target products 304 that they would like to see introduced in their primary/home geographical area 50, such as indicated in FIG. 3C; and information about how a target product is introduced within their primary/home geographical area 50, as indicated in FIG. 3D.

As indicated in FIG. 3F, the set of seeker GUIs 310 further includes an image capture GUI 310f that provides an image capture function such as a camera button 312 responsive to seeker input for capturing at least one image 302b of a target product 304b can be captured; and within which the target product image(s) captured by the seeker can be displayed. In some embodiments, the image capture GUI 310f can have associated therewith or include a text box (not shown) configured for receiving seeker text input directed to describing target product details; in certain embodiments, the image capture GUI 310f can additionally or alternatively have associated therewith or include an audio input interface (not shown) by which the seeker can select (e.g., by way of audio file selection) and/or input (e.g., by way of their voice) audio information corresponding to the target product under consideration. The image capture GUI 310f can additionally present a message to the seeker, such as “I want this in <primary/home geographical area 50>”. The image capture GUI 310f can also provide a submission function such as a submit/send button 314. In response to seeker selection of the submit button 314, the seeker mobile app generates and submits a target product verification request to the product introduction/supply chain management server 100. In several embodiments, the target product verification request includes a seeker ID; a time and date stamp; a location identifier such as an IP address and/or a set of geospatial coordinates (e.g., global positioning satellite (GPS) coordinates); and at least one captured image of the target product.

The seeker mobile app can additionally provide a number of additional or other GUIs, such as one or more of a seeker profile GUI 310g as indicated in FIG. 3G; a similar products GUI 310h as indicated in FIG. 3H; a target product demand GUI 310i as indicated in FIG. 3I; and a product availability GUI 310j as indicated in FIG. 3J. For a given seeker, an embodiment of a seeker profile GUI 310g presents seeker profile information corresponding to this seeker, which can include a seeker picture; a seeker rating; a number of candidate new products the seeker discovered; the number of candidate new products associated with the seeker which have actually been designated as new/introduced products in the seeker's primary/home geographical area 50; a number of other seekers following this seeker; a number of seekers this seeker is following; and images 302c-k of new/introduced products that this seeker found. The seeker profile GUI 310g can also provide a number of seeker selectable input elements, which can facilitate seeker-to-seeker communication/social media information exchange.

For a given candidate new product under consideration, an embodiment of a similar products GUI 310h such as that shown in FIG. 3H presents an image 302 of the candidate new product 305, and can additionally present a product description; an overall number of seekers across all target geographical areas 50 who submitted target product verification requests corresponding to this candidate new product 305a; a number of seekers in the primary/home geographical area 50 of the seeker to whom the seeker communication device 300 corresponds that submitted target product verification requests corresponding to this candidate new product 305a; the identity of the first-to-submit/discovering seeker within this primary/home geographical area 50; a current status of this candidate new product 305a, such as a status relative to venture orders (e.g., “Pending for Backers”) for the candidate new product 305a; and images 3021-o of other similar products, which are under consideration for introduction or are available in the seeker's primary/home geographical area 50.

An embodiment of a product demand GUI 300i such as that shown in FIG. 3I presents an image 302p of a given candidate new product 305b, along with a corresponding product description, an overall number of seekers across all target geographical areas 50 that submitted target product verification requests corresponding to this candidate new product 305b; a number of seekers in the primary/home geographical area 50 of the seeker to whom the seeker communication device 300 corresponds that submitted target product verification requests corresponding to this candidate new product 305a; the identity of the first-to-submit/discovering seeker within this primary/home geographical area 50; a current status of this candidate new product 305a, such as a product unavailability notification for the aforementioned primary/home geographical area 50; and a product located submission button 316 by which the seeker to whom the seeker communication device 300 corresponds can submit location information corresponding to a retail location or retailer at which they saw this candidate new product 305b in their primary/home geographical area 50. The product demand GUI 300i can additionally present images 302q-t of other candidate new products for this seeker's primary/home geographical area 50, where such images can be individually selected.

An embodiment of a product availability GUI 310j such as that shown in FIG. 3J presents an image 302k of a former candidate new product that has been designated as a new/introduced product within the primary/home geographical area 50 of the seeker to whom the seeker communication device 300 corresponds. The product availability GUI 310j additionally presents location information (e.g., by way of a map) corresponding to businesses within this seeker's primary/home geographical area 50 at which this new/introduced product 306 is available, along with website access for placing online orders for this new/introduced product. The product availability GUI 310j can also present seeker demand information corresponding to this new/introduced product 306 and a discovering seeker identify in a manner analogous to that described above.

Various embodiments in accordance with the present disclosure additionally provide a set of target product recognition/identification GUIs by which a seeker can (a) scan through images of target products that have not yet been identified or accurately identified (e.g., for which a product name has not yet been determined or accurately determined); (b) select an image of a target product that the seeker recognizes; and (c) enter target product identification information, including a product name and possibly a product category, a product source (e.g., manufacturer), and/or country of origin for the recognized target product. For instance, FIGS. 3K and 3L show an embodiment of a first and a second target product recognition/identification GUI 310k,l in accordance with an embodiment of the present disclosure. The first target product recognition/identification GUI 310k presents a number of user selectable images 303a-x, each of which shows at least a portion of a yet-to-be-identified target product 308a-x. Each user selectable image 303a-x can be a reference image showing at least portions of a yet-to-be-identified target product 308a-x. In response to seeker selection of a given image 303 of a particular yet-to-be-identified target product 308 within the first target product recognition/identification GUI 310k, the second target product recognition/identification GUI 3101 presents the selected image 303 of the yet-to-be-identified target product 308 (e.g., in a larger of higher resolution format), and provides a number of text boxes 307 configured for receiving seeker input defining target product identification information for this target product 308. For instance, such text boxes 307 can include a first text box 307a for entry and receipt of a product name (e.g., a potential product name, which the seeker expects or believes to be the actual product name); and possibly a second text box 307b for entry/selection and receipt of a product category, and/or a third text box 307c for entry and receipt of a product origin.

The second target product recognition/identification GUI 3101 can also include a product information submission button 309. In response to seeker selection of the product identification submission button 309, the seeker mobile device 300 can communicate a product identification submission to the product introduction/supply chain management server 100. The product identification submission can include a seeker ID and possibly a code or designation corresponding to the seeker's primary/home geographical area 50; the target product identification information (e.g., the contents of the text boxes 307) that the seeker mobile device 300 received from the seeker; an ID or code corresponding to the image 303 of the yet-to-be-identified target product 308 and/or possibly this image 303 itself; and in some embodiments a time/date stamp. In various embodiments, the target product identification information should include at least a product name. As further detailed below, the product introduction/supply chain management server 100 can utilize such product identification information to aid accurate or enhanced accuracy identification of a yet-to-be-identified target product 308 under consideration, such as by way of determining a most frequently or most commonly submitted product name for the yet-to-be-identified target product 308 across a total of T (for instance, 10-1000, e.g., 20-500, or 50-100) target product identification submissions received from different seeker mobile devices 300. The product introduction/supply chain management server 100 can track or monitor product names submitted for the yet-to-be-identified target product 308 over time (e.g., across a predetermined time period, such as a given number of days or weeks), and can select the most frequently/commonly submitted product name as the most likely or actual name of this target product 308.

In some embodiments, the product introduction/supply chain management server 100 can allocate electronic credits or award amounts, such as online purchase credits, to the first k seekers whose submitted product names match the most frequently or most commonly submitted product name within the T target product identification submissions. Consequently, those first k seekers can utilize such credits to offset the price of purchasing one or more target products online by way of the product introduction/supply chain management server 100. Additionally, a seeker can accumulate an increasing number of such credits in accordance with the cumulative number of yet-to-be-identified target products 308 the seeker correctly or consistently identifies as early as possible. In a number of embodiments, the set of target product recognition/identification GUIs 310k,l is presented in a game format.

An individual having ordinary skill in the relevant art will understand that the representative GUIs 310a-m described herein are provided for purpose of illustration to aid understanding, and an embodiment in accordance with the present disclosure can provide modified, additional, or other types of GUIs 310. For instance, FIG. 3M illustrates another image capture GUI 310m, which is responsive to seeker input for capturing at least one image 302u of a target product 304u, and which is further responsive to seeker input directed to rating the target product 304u in accordance with one or more rating categories, such as product look, taste, nutrition, and value. An individual having ordinary skill in the relevant art will further understand that while the aforementioned GUIs 310 are described in the context of their presentation on seeker mobile devices 300, such GUIs 310 can analogously or equivalently be provided to function with essentially any type of seeker computing device 300 (e.g., a desktop or laptop computer).

### Representative Aspects of Target Product Verification Request Processes

As indicated above, the product introduction/supply chain management server 100 processes target product verification requests received from seeker computing devices 300 in order to facilitate or enable determination of whether a target product corresponding to a target product verification request is (a) already available from an existing distributor; (b) already available as a new/introduced product managed by the product introduction/supply chain management server 100; (c) has previously been designated as a candidate new product by the product introduction/supply chain management server 100; (d) should be designated as a candidate new product by the product introduction/supply chain management server 100; or (e) has been designated as an evaluation product in the target geographical area 50 under consideration.

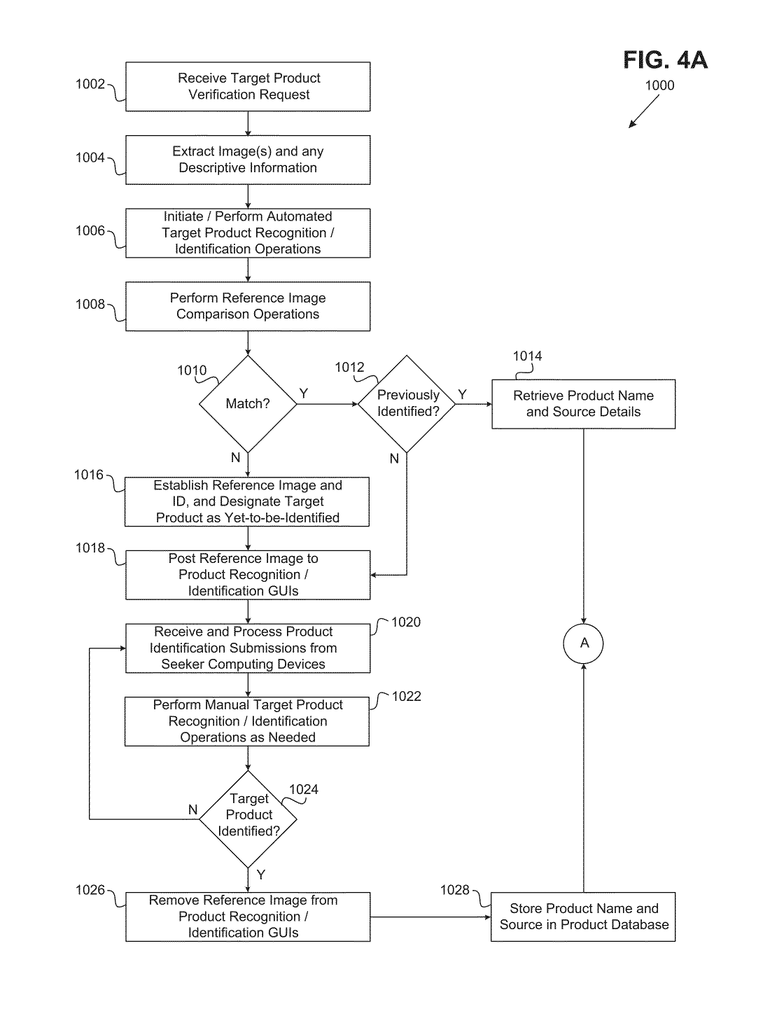

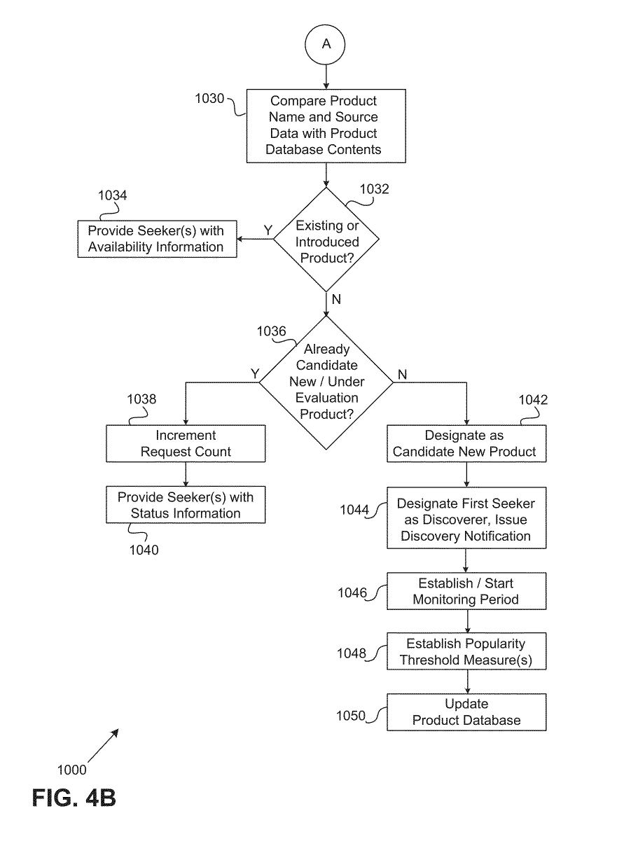

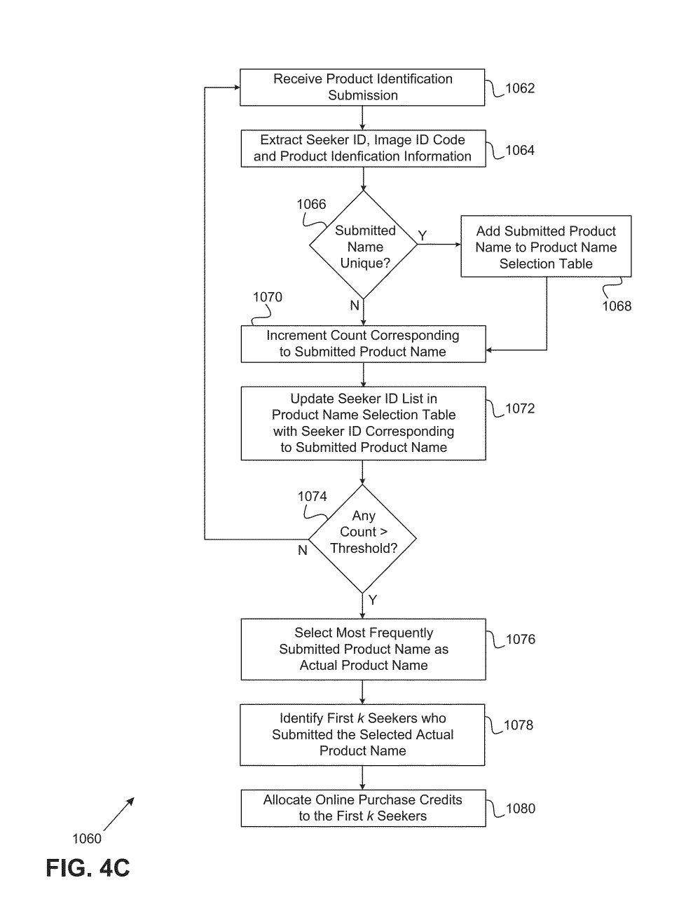

FIGS. 4A-4B are flow diagrams of representative processes 1000 for processing target product verification requests in accordance with an embodiment of the present disclosure. In a first process portion 1002 the product introduction/supply chain management server 100 receives a target product verification request from a seeker computing device 300, which includes a seeker ID, a set of images showing a target product under consideration, and possibly related information (e.g., text and/or audio information corresponding to the target product). In a second process portion 1004, the product introduction/supply chain management server 100 extracts a set of target product images from the target product verification request, and possibly non-image information (e.g., descriptive text information, and/or audio information) associated therewith.

In a third process portion 1006, the product introduction/supply chain management server 100 initiates and/or performs image recognition/identification/comparison/matching operations in an attempt to automatically identify using information contained in the target product verification request the product name and product source (e.g., a manufacturer or distributor) of the target product under consideration. In various embodiments, such operations involve the execution of one or more image recognition/identification/comparison/matching/applications/processes/algorithms by which image content in the extracted image(s) is recognized/identified/compared/matched relative to images stored in one or more databases, which can be local or remote with respect to the product introduction/supply chain management server 100. Depending upon embodiment details, the execution of the image recognition/identification/comparison/matching/recognition application(s)/process(es)/algorithm(s) can occur locally with respect to the product introduction/supply chain management server 100; and/or remotely with respect to the product introduction/supply chain management server 100, such as by way of communication with one or more image recognition/identification/comparison/matching services (e.g., a cloud-based service), as further detailed hereafter.

For instance, in some embodiments the product introduction/supply chain management server 100 automatically or semi-automatically communicates with one or more image recognition/identification engines or services as part of the third process portion 1006. Such communication can include automatic, semi-automatic, or manual image submission to and information exchange with a search engine providing visual or image-based search and recognition functionality (e.g., a “visual search engine/service”). Moreover, such communication can involve the transfer of one or more images and associated visual search instructions, commands, or parameters to a visual search engine/service by way of an Application Program Interface (API) corresponding thereto, such as the API associated with CamFind (ImageSearcher, Inc., Los Angeles, Calif. USA). In certain embodiments, the image(s) transferred to the visual search engine/service can include an image showing portions of the target product itself, and/or an image of a corresponding product QR code or bar code, which can facilitate accurate recognition/identification of the name or source of the target product, or a Universal Record Locator (URL) associated therewith. The product introduction/supply chain management server 100 can additionally or alternatively communicate with another visual search engine/service such as Google “Search by Image” (Google Inc., Mountain View, Calif. USA) and/or a cloud-based service such as ViSearch (ViSenze Pte Ltd., Singapore), in a manner readily understood by an individual having ordinary skill in the relevant art. The product introduction/supply chain management server 100 can associate or link a “best match” result returned from a visual search engine/service with the image(s) extracted from the target product verification request under consideration, and can store the extracted image(s) along with the best match result in the product database 142. The best match result can include a returned text string result corresponding to or specifying a product name, and/or a returned image result, depending upon the capabilities of a visual search engine/service under consideration.

In association with a fourth and a fifth process portion 1008, 1010, the product introduction/supply chain management server 100 can determine whether the target product shown in (a) an extracted image corresponding to the current target product verification request or (b) a corresponding best match result returned from a visual search engine/service has been previously considered during the processing of a prior target product verification request. More particularly, in an embodiment the product introduction/supply chain management server 100 initiates or performs a set of reference image comparison operations to determine whether the target product shown in an extracted image corresponding to the current target product verification request and/or a visual search engine/service returned image result is already present within a reference image that is stored in the product database 142 and which is associated or linked with the target geographical area 50 under consideration. The reference image comparison operations can involve the execution of one or more conventional image comparison/matching processes or algorithms, which can generate one or more image comparison metrics or measures indicating the likelihood of a match.

If no match exists, or a match is indicated as highly unlikely (e.g., less than 10% likelihood of a match), the product introduction/supply chain management server 100 can establish the extracted image or an associated visual search engine/service returned image result as a reference image corresponding to the target product in a sixth process portion 1012; generate a corresponding reference image ID or code; and designates the target product under consideration as a yet-to-be-identified product. If a match exists, or is indicated as highly likely (e.g., more than 90% likelihood of a match), the product introduction/supply chain management server 100 determines whether the target product shown in the reference image has already been successfully identified in a seventh process portion 1014. If so, the product introduction/supply chain management server 100 retrieves a product name and product source data corresponding to this target product in an eighth process portion 1016, and subsequently initiates a set of product status notification operations in a fifteenth process portion 1030, as further described in detail below.

If a product name for the target product shown in the reference image has not yet been successfully identified, the product introduction/supply chain management server 100 adds this reference image to a product recognition/identification GUI posting list in a ninth process portion 1018, such that the reference image can be posted to product recognition/identification GUIs 310k,l provided by seeker computing devices 300. In a tenth process portion 1020, the product introduction/supply chain management server 100 receives and processes product identification submissions from seeker computing devices 300 to select/determine a product name for the target product under consideration, for instance, in a manner indicated above and/or further detailed below with reference to FIG. 4C.

If the product introduction/supply chain management server 100 cannot determine the product name and source(s) of the yet-to-be-identified product under consideration by way of the first through tenth process portions 1002-1020, the product introduction/supply chain management server 100 can initiate or manage the performance of manual product recognition/identification operations in an eleventh process portion 1022. In association with the eleventh process portion 1022, the product introduction/supply chain management server 100 can generate an auxiliary target product verification request directed to a system operator, or an external service. The system operator or external service can subsequently determine or attempt to determine the product name and source(s) of the yet-to-be-identified product using information contained in the auxiliary target product verification request, and can return a corresponding product name and product source to the product introduction/supply chain management server 100. Depending upon embodiment details, the eleventh process portion 1022 can be excluded, performed on an optional basis, or routinely performed.

In a twelfth process portion 1024, the product introduction/supply chain management server 100 determines whether a product name for the target product under consideration has been successfully selected/determined. If not, the process 1000 can return to the tenth process portion 1020. Otherwise, the product introduction/supply chain management server 100 can remove or delete the reference image corresponding to the target product consideration from the product recognition/identification GUI list in a thirteenth process portion 1026, and store the selected/determined product name and source in a fourteenth process portion 1028.

Once a product name and source for the target product under consideration have been selected/determined the product introduction/supply chain management server 100 compares product name and source data with product database contents 142 in a fifteenth process portion 1030. In a sixteenth process portion 1032, the product introduction/supply chain management server 100 determines based upon product database contents whether the target product is already an existing product or a new/introduced product in the target geographical area under consideration 50. If so, the product introduction/supply chain management server 100 issues in a seventeenth process portion 1034 a product availability notification to the seeker communication device 300 under consideration, which indicates one or more businesses and/or locations within this target geographical area 50 the product is available.

If the target product under consideration is not already an existing product or a new/introduced product in the target geographical area 50 under consideration, the product introduction/supply chain management server 100 determines in an eighteenth process portion 1036 whether the target product is currently a candidate new product or an evaluation product in the target geographical area 50 under consideration. If so, the product introduction/supply chain management server 100 increments a target product verification request count corresponding to the candidate new or evaluation product in a nineteenth process portion 1038, and issues a target product status notification to the seeker communication device 300 under consideration in a twentieth process portion 1040.

If the product introduction/supply chain management server 100 determines in association with the eighteenth process portion 1036 that the target product under consideration is not currently a candidate new product or an evaluation product in the target geographical area 50 under consideration, the product introduction/supply chain management server 100 designates the target product as a candidate new product in an twenty first process portion 1042; identifies the seeker corresponding to the seeker ID associated with the target product verification request as the discovering seeker in a twenty second process portion 1044; and establishes or initiates monitoring period for the candidate new product in a twenty third process portion 1046. The length of the monitoring period can depend upon embodiment details, the nature of the candidate new product, and/or the size of the target geographical area 50 under consideration. For instance, the monitoring period can be a selectable/programmably specified number of weeks (e.g., 2-8 weeks) or months (e.g., 1-3 months). The product introduction/supply chain management server 100 can additionally establish, determine, or define a popularity measure or threshold for the candidate new product in a twenty fourth process portion 1048. In various embodiments, the popularity threshold includes or is defined by a minimum number of target product verification requests corresponding to the candidate new product that must be received prior to or by the expiration of the monitoring period in order for the candidate new product to be designated as an evaluation product, as further elaborated upon below.

Finally, in a twenty fifth process portion 1050, the product introduction/supply chain management server 100 updates information in the product database 142 corresponding to the candidate new product. In an embodiment, such information can include the product name, one or more product sources (e.g., the product manufacturer and possibly a number of distributors), the seeker ID of the discovering seeker, the monitoring period, the popularity threshold, and a current cumulative number of target product verification requests received corresponding to this candidate new product since its designation as a candidate new product.

FIG. 4C is a flow diagram of a representative process 1060 for processing product identification submissions received from seeker computing devices 300 in accordance with an embodiment of the present disclosure. In an embodiment, the process 1060 includes a first process portion 1062 in which the product introduction/supply chain management server 100 receives a product identification submission corresponding to a yet-to-be-identified product, and a second process portion 1064 in which the product introduction/supply chain management server 100 extracts a seeker ID, possibly a target geographical area designation corresponding to the seeker ID, a reference image ID code, and product identification information from the product identification submission. The product identification submission includes at least textual or verbal information representing a potential or possible product name for the yet-to-be-identified product.

In a third process portion 1066, the product introduction/supply chain management server 100 determines whether the submitted product name (e.g., the potential/possible product name specified by the product identification submission under consideration) is unique with respect to previously received product identification submissions corresponding to this yet-to-be-identified product for the target geographical area 50 under consideration. The third process portion 1066 can involve searching for the submitted product name in a product name selection table associated with the yet-to-be-identified product within the product database 142. If the submitted product name is unique, in a fourth process portion 1068 the product introduction/supply chain management server 100 adds this submitted product name to the product name selection table associated with the yet-to-be-identified product.

Regardless of whether the submitted product name is unique or non-unique, in a fifth process portion 1070 the product introduction/supply chain management server 100 increments a count (e.g., which is maintained as part of the submitted product name table) corresponding to the submitted product name to thereby maintain a cumulative count of the number of product identification submissions that have included this particular submitted product name. Such a cumulative count can facilitate the tracking or monitoring of the most frequently/commonly submitted product name(s), and the identification of an accurate or most likely product name corresponding to the yet-to-be-identified product. In a sixth process portion 1072, the product introduction/supply chain management server 100 adds the seeker ID corresponding to the product identification submission under consideration to a seeker ID list associated with or within the product name table, such that the seeker ID corresponding to each received product identification submission can subsequently be determined or tracked.

In a seventh process portion 1074, the product introduction/supply chain management server 100 determines whether the cumulative count corresponding to any submitted product name for the yet-to-be-identified product under consideration meets or exceeds a product name selection threshold (e.g., 10-1000, or 20-500, or 50-100). If not, the process 1060 can return to the first process portion 1060. Otherwise, the product introduction/supply chain management server 100 selects the submitted product name for which the cumulative count meets or exceeds the name selection threshold as the target product name in an eighth process portion 1076. In a number of embodiments, in a ninth process portion 1078 the product introduction/supply chain management server 100 additionally identifies the first k seekers (e.g., 10-20 seekers, where k can be predetermined or programmably specified) whose product identification submissions contained the selected product name. The product introduction/supply chain management server 100 subsequently allocates an online purchase credit to each such seeker in a tenth process portion 1080, which each of these seekers can utilize to offset the purchase price of products purchased online by way of the product introduction/supply chain management server 100.

In certain embodiments, the product introduction/supply chain management server 100 can utilize a returned text string result from a visual search engine/service to aid selection or confirmation of the most likely or actual/accurate product name, for instance, by comparing the returned text string provided by the visual search engine/service with the most frequently/commonly submitted product name obtained by way of receiving and processing product identification submissions. In other embodiments, the product introduction/supply chain management server 100 can compare returned text string results from multiple visual search engines to aid selection or confirmation of the most likely or actual/accurate product name, either in association with the receipt and processing of product identification submissions, or in the absence of the receipt and processing of product identification submissions.

### Representative Aspects of Candidate New Product Processes

As indicated above, once the product introduction/supply chain management server 100 has designated a target product as a candidate new product for a target geographical area 50 under consideration, the product introduction/supply chain management server 100 can monitor or track subsequently received target product verification requests corresponding to this candidate new product received from seekers, for purpose of determining an estimated popularity level of the candidate new product in this target geographical area 50.

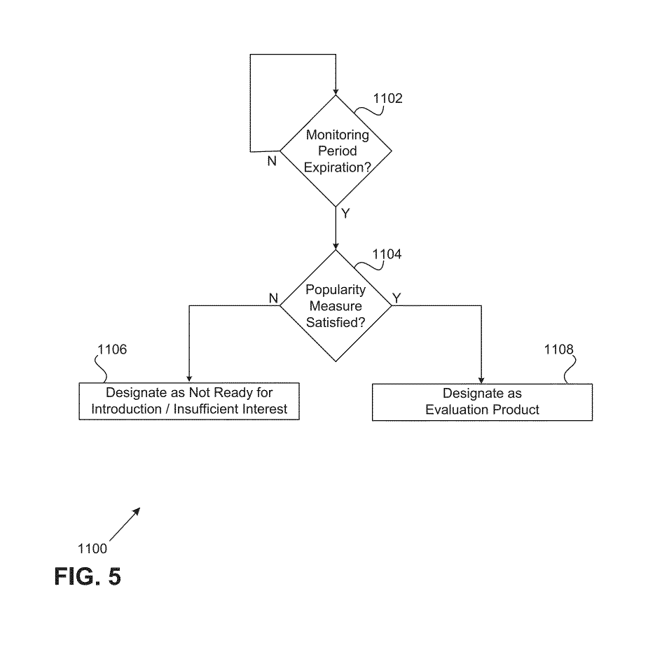

FIG. 5 is a flow diagram of a representative process 1100 for determining whether a candidate new product should be designated as an evaluation product in a given target geographical area 50 in accordance with an embodiment of the present disclosure. In a first process portion 1102, the product introduction/supply chain management server 100 determines whether an expiration of the monitoring period for the candidate/new product under consideration for the target geographical area 50 under consideration has been reached. If not, the first process portion 1102 does not advance. If the monitoring period's expiration has been reached, the product introduction/supply chain management server 100 determines in a second process portion 1104 whether the popularity threshold for the candidate new product in this target geographical area 50 has been reached. If not, the product introduction/supply chain management server 100 designates the candidate new product as not ready for introduction or lacking sufficient interest in this target geographical area 50 in a third process portion 1106. The product introduction/supply chain management server 100 can additionally issue an insufficient interest notification to the discovering seeker in association with the third process portion 1106. If the popularity threshold for the candidate new product has been reached, the product introduction/supply chain management server 100 designates the candidate new product as an evaluation product in the target geographical area 50 under consideration in a fourth process portion 1108.

### Representative Aspects of Evaluation Product and Rating Event Processes

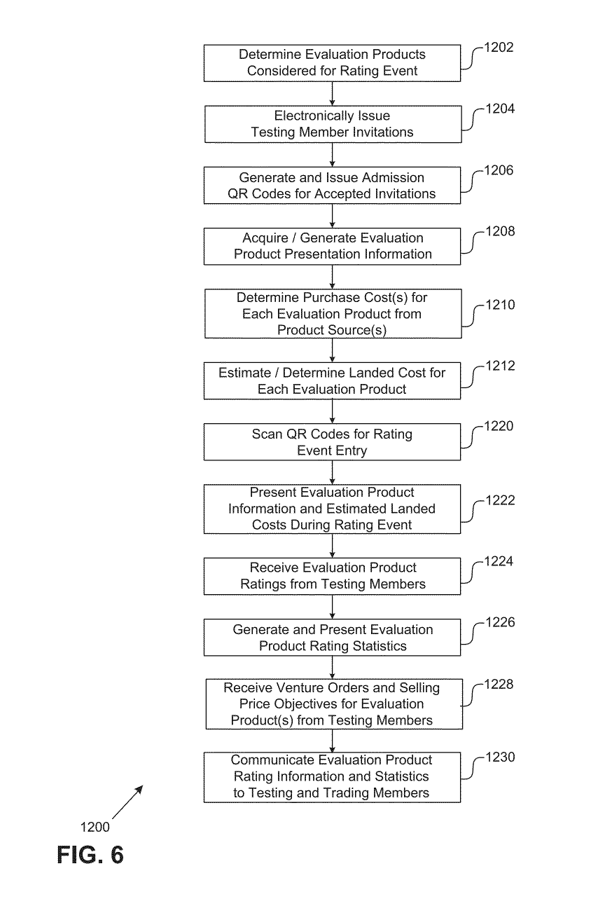

FIG. 6 is a flow diagram of a representative process 1200 for managing evaluation products and product rating events in accordance with an embodiment of the present disclosure.

### Prior to Product Rating Event

In an embodiment, the process 1200 includes a first process 1202 involving determination of a set of evaluation products to be presented at an upcoming product rating event that will be held in a target geographical area 50 under consideration. The first process portion 1202 can include product introduction/supply chain management server 100 analysis of the product database 50 and generation of a list of evaluation products for potential presentation at the upcoming product rating event, possibly in accordance with one or more product rating event schedules. The first process portion 1202 can additionally or alternatively involve manual or semi-automatic operations, in which a system operator selects or designates particular evaluation products for presentation at the upcoming product rating event.

In a second process portion 1204, the product introduction/supply chain management server 100 electronically issues product rating event invitations (e.g., by way of e-mail messages, text messages, or other types of messages/notifications) to testing members within the target geographical area 50 under consideration. In response to receipt of an accepted invitation from a testing member, the product introduction/supply chain management server 100 generates a QR code corresponding to the testing member and the product rating event, and communicates the QR code to the testing member in a third process portion 1206. For each testing member that has received a QR code, their QR code can serve as an admission authorization or ticket for the product rating event.

A fourth process portion 1208 involves acquiring and/or generating presentation information for each evaluation product that will be presented at the product rating event. Such information can include, for example, detailed product descriptive information, promotional information, product marketing data, and/or other information, and can be stored in the product database 142.

A fifth process portion 1210 involves determining for each evaluation product to be presented at the product rating event an estimated or actual cost of purchasing the evaluation product from at least one, and typically two or more, sources. In various embodiments, such purchase costs can include, for instance, a lowest purchase cost and a higher or highest purchase cost. The lowest purchase cost can correspond to the cost of obtaining the evaluation product directly from its manufacturer; and the higher or highest purchase cost can correspond to the cost of obtaining the evaluation product from a product distributor.

A sixth process portion 1212 involves estimating or determining for the target geographical area under consideration 50 a total landed cost for each evaluation product to be presented at the product rating event. The total landed cost can be defined as a mathematically derived estimated purchase cost or actual purchase cost, plus all costs associated with product importation into the target geographical area 50, including shipping/handling costs, logistics costs (e.g., storage/palletization, and container unstuffing costs), customs duties, and the like. In a number of embodiments, the mathematically derived estimated purchase cost can be defined as an average of the lowest purchase cost and the highest purchase cost for the evaluation product under consideration.

### At/During Product Rating Event

A seventh process portion 1220 involves scanning testing member QR codes at a product rating event venue, for purpose of selectively verifying or authorizing testing member entry to the product rating event. An eighth process portion 1222 involves presentation of at least some of the aforementioned evaluation product presentation information during the product rating event, for instance, before or while the testing members test or sample the evaluation products presented thereat. Such presentation can occur by way of communication between the rating event management system 400 and the main/central rating event display(s) 410 and/or each testing member's rating event computing device 500.

A ninth process portion 1224 involves receiving evaluation product rating information from testing members, by way of communication between testing member rating event computing devices 500 and the event management server 400 and/or the product introduction/supply chain management server 100. A tenth process portion 1226 involves generating evaluation product rating statistics or data corresponding to each evaluation product for which testing members submitted rating information. Such rating statistics/data can be generated by way of the product introduction/supply chain management server 100 or the event management server 400, depending upon embodiment details. The tenth process portion 1226 can additionally involve the presentation of such rating statistics/data to testing members by way of the main/central rating event display(s) 410 and/or each testing member's rating event computing device 500.

An eleventh process portion 1228 involves receiving from testing members at the product rating event venture orders and selling price objectives for particular evaluation products. Each venture order identifies or corresponds to a given evaluation product, and indicates an evaluation product quantity that the testing member intends to order, such that retail sales of the evaluation product associated with the testing member in the target geographical area 50 under consideration can occur. Such retail sales can occur by way of the sale of product stock at one or more physical business locations associated with the testing member, or by way of online sales managed by the product introduction/supply chain management server 100, as further detailed below. In a venture order, a selling price objective for the evaluation product specifies a price at which the testing member expects or believes that the product can or should be sold. In view of the foregoing, each venture order received from a testing member indicates or specifies that the testing member is willing to commit an investment in the evaluation product corresponding to the venture order, for purpose of purchasing the evaluation product from a given product source (e.g., a manufacturer or distributor) outside of the target geographical area 50 under consideration, such that the testing member can offer by way of retail sales pricing the evaluation product as a new/introduced product in the target geographical area 50. In various embodiments, testing members can enter or input venture order information by way of their rating event computing device 500, which can communicate each venture order to the event management system 410 and/or the product introduction/supply chain management server 100. A rating event computing device 500 can provide a venture order entry GUI, which can have a standardized format (e.g., in accordance with a venture order template), for purpose of receiving venture order information from a testing member.

Finally, a twelfth process portion 1230 involves communication of rating statistics/data and possibly evaluation product information to testing members and trading members, including testing members that did not attend the product rating event. In several embodiments, such communication occurs on the same day or the day after the product rating event. For those evaluation products considered at the product rating event, such communication facilitates the placement of additional venture orders for particular evaluation products from testing members and trading members, for a limited period of time as further elaborated upon below.

### Representative Aspects of Venture Order and Product Importation Processes

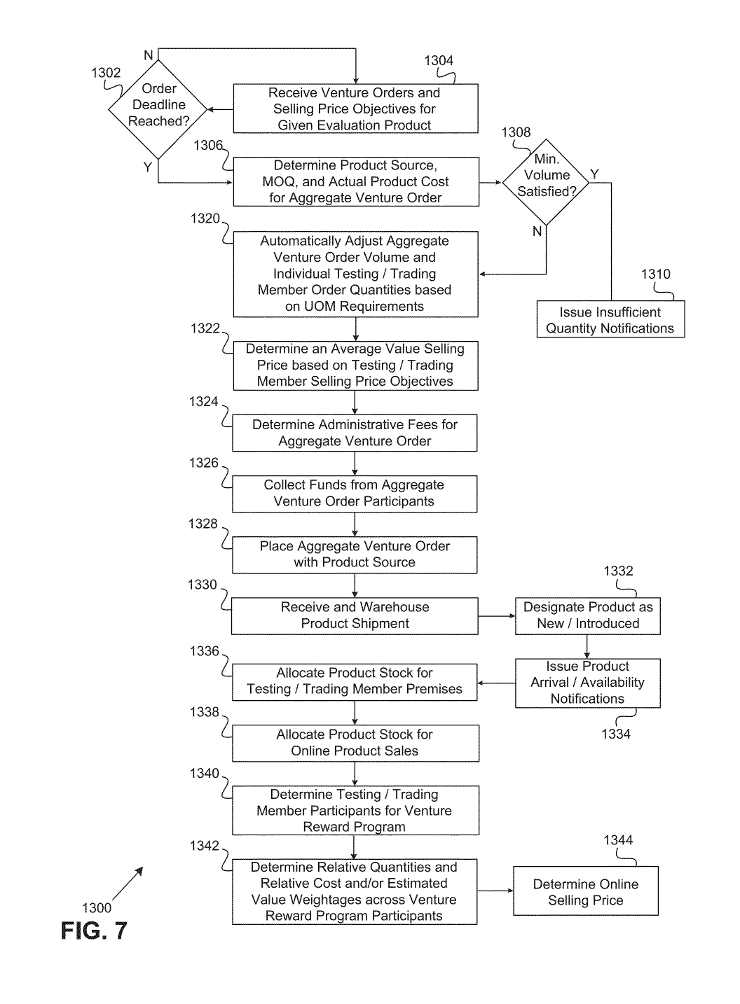

FIG. 7 is a flow diagram of a representative process 1300 for managing venture orders and product importation directed to a target geographical area 50 under consideration in accordance with an embodiment of the present disclosure. In an embodiment, the process 1300 includes a first process portion 1302 in which the product introduction/supply chain management server 100 determines whether an order deadline for an evaluation product under consideration in the target geographical area 50 has been reached. Depending upon embodiment details, the nature of the evaluation product, and/or the nature of the target geographical area 50, the order deadline can be a predetermined number of days (e.g., 7-14 days) or weeks (e.g., 1-3 weeks) from the date of the product rating event at which the evaluation product was presented and sampled/rated/tested in the target geographical area 50. If the deadline has not been reached, the product introduction/supply chain management server 100 can receive venture orders and selling price objectives for the evaluation product from testing members and trading members in a second process portion 1304. In a manner essentially identical to that described above, each venture order received from a testing member or trading member indicates or specifies that the testing member or trading member, respectively, is willing to commit an investment in the evaluation product corresponding to the venture order, for purpose of a) purchasing the evaluation product from a given product source (e.g., a manufacturer or distributor) outside of the target geographical area 50 under consideration, and b) selling on a retail basis the evaluation product as a new/introduced product in the target geographical area 50. Such retail sales can occur by way of sales at physical business locations corresponding to the testing members or trading members, or online sales associated with the testing members or trading members, in the target geographical area 50 under consideration.

Once the order deadline has been reached, the product introduction/supply chain management server 100 aggregates all individual venture orders received for the evaluation product in the target geographical area 50 to create an aggregated venture order for the evaluation product in this target geographical area 50 in a third process portion 1306. The third process portion 1306 also involves determining or finalizing a product source (e.g., a manufacturer or distributor); a minimum order quantity (MOQ); and an actual product purchase cost for the evaluation product.

A fourth process portion 1308 involves determining whether a minimum order quantity (MOQ) associated with the product source has been satisfied. If not, the product introduction/supply chain management server 100 can issue a set of insufficient quantity notifications to the testing members and trading members who placed venture orders for the evaluation product under consideration in a fifth process portion 1310. In association with the fifth process portion 1310, the product introduction/supply chain management server 100 can additionally extend or reset the order deadline, such that additional venture orders for the evaluation product can be received.

A sixth process portion 1320 involves adjusting an aggregate venture order volume and individual testing member and trading member order quantities therein, in accordance with the MOQ and order unit of measure (UOM) requirements. For instance, in the event that an aggregate venture order volume is 1.2 pallets of a given evaluation product and a MOQ of 1 pallet has been satisfied, but the UOM is 1 pallet and hence a fractional pallet cannot be ordered, the aggregate venture order is either too large by 0.2 pallet or too small by 0.8 pallet and needs to be adjusted accordingly. In various embodiments, aggregate venture orders that involve a fractional UOM are scaled downward in size, provided such downward scaling still satisfies the MOQ requirement. Thus, for a 1.2 pallet order in this 1 pallet MOQ and 1 pallet UOM situation, the product introduction/supply chain management server 100 scales the initial aggregate venture order volume to have a final aggregate venture order volume of 1 pallet of the evaluation product under consideration. In other words, the product introduction/supply chain management server 100 scales the aggregate venture order volume by −16% to meet UOM constraints. In such a scaling, the product introduction/supply chain management server 100 accordingly/proportionally scales down the quantity of evaluation product ordered by each testing member and trading member, which in this example means a reduction in each testing member's order quantity and each trading member's order quantity be a factor of 16%. In multiple embodiments, the product introduction/supply chain management server 100 allocates any fractional aggregate venture order volume to a next or future aggregate venture order as part of a reordering process, as further detailed below.

A seventh process portion 1322 involves determining an average value selling price (AVSP) for the evaluation product under consideration. In various embodiments, the AVSP is mathematically determined or derived based on (a) the selling price objectives, and (b) order quantities specified by the testing member and trading members in their individual venture orders for the evaluation product under consideration. For instance, for each testing member and trading member, a total expected sales revenue corresponding thereto can be calculated as the testing or trading member's venture order volume, multiplied by their selling price objective. An aggregate expected sales revenue for the aggregate venture order can then be determined by simply adding each testing and trading member's total expected sales revenue. Finally, the AVSP can be determined by dividing the aggregate expected sales revenue for the aggregate venture order by the total quantity of the evaluation product to be ordered.

An eighth process portion 1324 involves determining an administrative fee imposed upon the testing members and trading members, such as a management fee corresponding to each aggregate venture order for the services provided to the testing members and trading members. In some embodiments, the administrative fee for each testing member or trading member is a predetermined percentage of the AVSP for the evaluation product, for instance, 3% of the AVSP, multiplied by the testing member's or trading member's scaled order volume for the evaluation product. In other embodiments, the administrative fee for each testing member or trading member is a predetermined percentage of the selling price objective set or specified by the testing member or trading member, respectively, for instance, 3% of their selling price objective, multiplied by their scaled order volume for the evaluation product. An individual having ordinary skill in the art will recognize that the manner in which an administrative fee and/or an associated imposed percentage are determined or selected can be different depending upon embodiment details, the nature of a target geographical area 50 under consideration, and/or the nature of the evaluation product under consideration.

A ninth process portion 1326 involves collecting funds for the aggregate venture order, and a tenth process portion 1328 involves placing the aggregate venture order with the product source. An eleventh process portion 1330 involves receiving one or more product shipments corresponding to the aggregate venture order in the target geographical area under consideration 50, and locally storing/warehousing the evaluation products corresponding thereto in the target geographical area 50. A twelfth process portion 1332 involves designating the evaluation product under consideration as a new/introduced product in the product database 432, and a thirteenth process portion 1334 involves issuing new/introduced product arrival and/or new/introduced product availability notifications to seeker computing devices 300, testing member computing devices 600, trading member computing devices 700, and buyer computing devices 800.

A fourteenth process portion 1336 involves allocating new/introduced product stock that is currently stored in the local warehouse(s) for transfer to testing member and/or trading member physical premises, such as physical business locations in the target geographical area 50 under consideration. A fifteenth process portion 1340 involves determining which testing members and trading members involved in the aggregate venture order will participate in a venture rewards program corresponding to online product sales, by way of making the portion their new/evaluation product stock that has not been allocated for transfer to testing member/trading member physical premises available for online sales. A sixteenth process portion 1342 involves determining relative cost and/or relative estimated value weightages across the venture reward program participants, by which online sales revenue is to be apportioned to the venture reward program participants in accordance with the estimated or actual total landed cost of the new/introduced product or the expected online sales value of the new/introduced product, in view of the venture reward program participants' relative order quantities within the aggregate venture order.

Finally, a seventeenth process portion 1344 involves determining or confirming an online selling price for the new/introduced product. In a number of embodiments, if all testing members and trading members that participated in the aggregate venture order are also participants in the venture reward program, and their entire new/introduced product stock is initially available for online sales, the online selling price can be selected as the AVSP described above. Otherwise, the online selling price can be determined in a manner analogous to that described above for determining the AVSP, by considering only those testing members and trading members who are participating in the venture reward program, and considering the relative quantities of new/introduced product corresponding to each such testing member and trading member that are available for online sales.

### Representative Aspects of Online Order and Venture Order Profit Management Processes

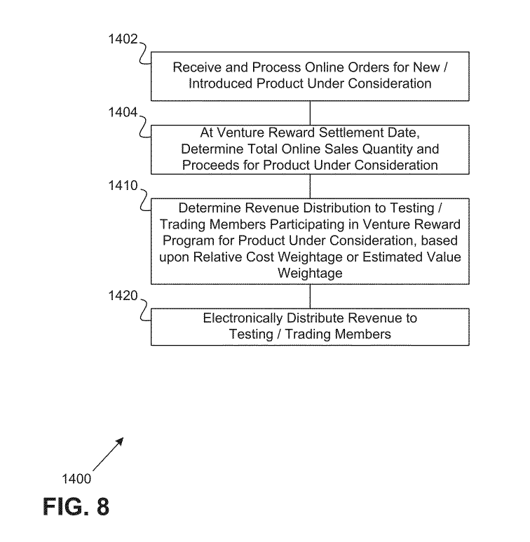

FIG. 8 is a flow diagram of a representative process 800 for managing online product orders or sales and venture order profits in accordance with an embodiment of the present disclosure. In an embodiment, the process 800 includes a first process portion 802 involving receiving and processing online orders submitted by buyers for a new/introduced product under consideration. In association with or as part of the first process portion 802, the new product introduction/supply chain management server 100 can verify a buyer member ID, and can further verify the buyer's delivery address within the target geographical area 50 under consideration. A second process portion 804 involves determining at a venture reward settlement date a total online sales quantity and total online sales proceeds for the new/introduced product. Depending upon embodiment details, the venture reward settlement date can be a recurring date, such as the end or beginning of each month or calendar quarter. A third process portion 810 involves apportioning online sales revenue among testing members and trading members participating in the venture reward program for the new/introduced product under consideration, based upon the relative cost weightage or the relative estimated value weightage mentioned above. Finally, a fourth process portion 820 involves distributing online sales revenue to the venture reward program participants. Such revenue distribution can occur electronically, such as by way of electronic funds transfer in a specified currency or digital currency (e.g., Bitcoin) transfer to a financial account corresponding to a testing member or trading member under consideration.

### Representative Aspects of Product Reordering Processes

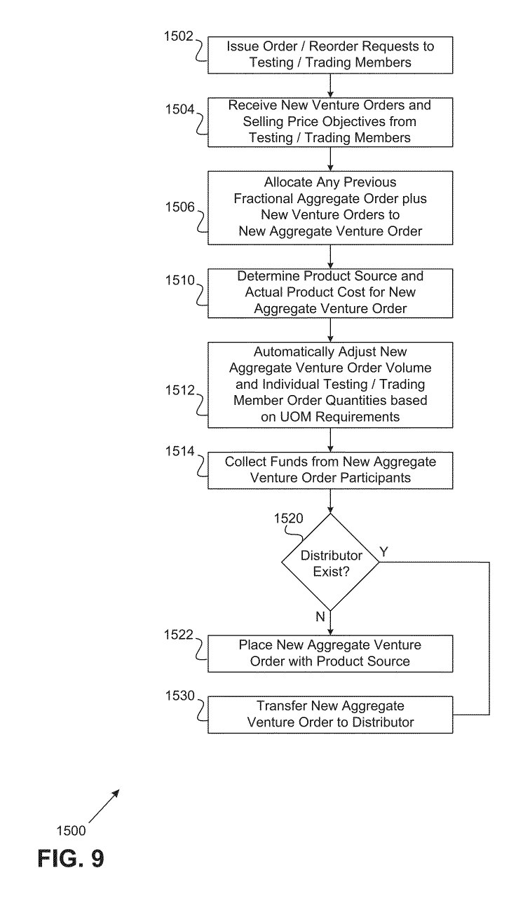

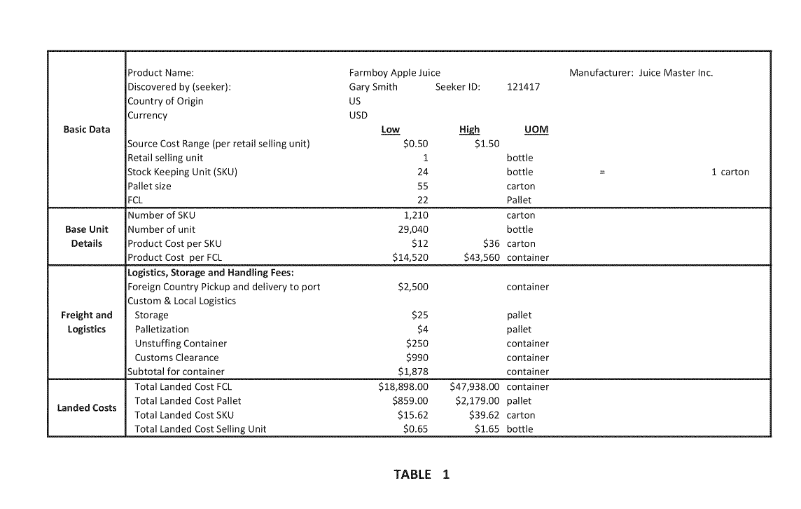

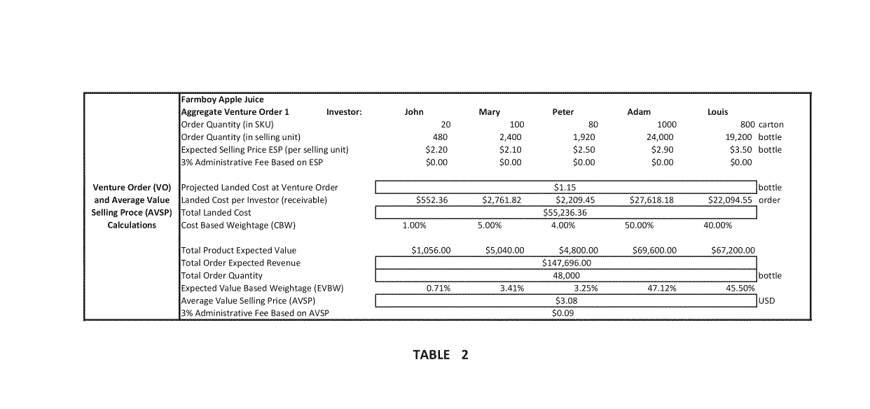

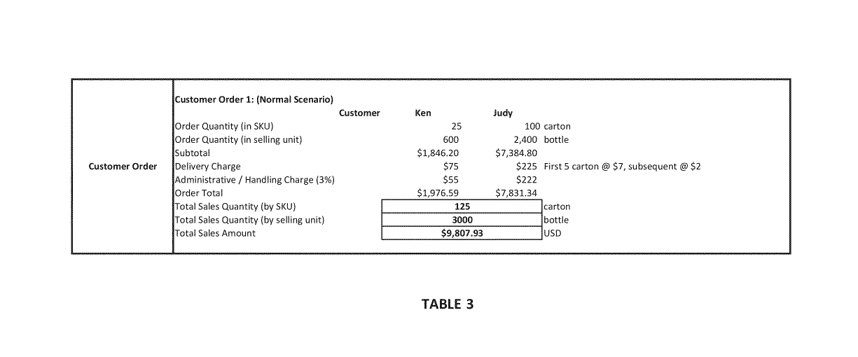

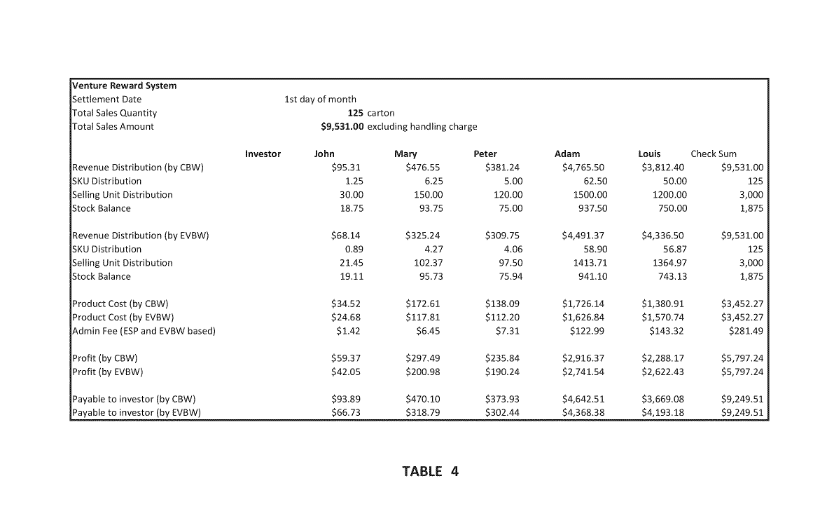

FIG. 9 is a flow diagram of a representative process 1500 for managing new/introduced product reordering in a target geographical area 50 under consideration in accordance with an embodiment of the present disclosure. In an embodiment, the process 1500 includes a first process proportion 1502 in which the product introduction/supply chain management server 100 issues order/reorder requests for the new/introduced product. Such requests can be communicated to testing member and trading member computing devices 600, 700 corresponding to testing members and trading members whose primary/home geographical area 50 is the target geographical area 50 under consideration. In a second process portion 1502, the product introduction/supply chain management server 100 receives new venture orders and selling price objectives for the new/introduced product from testing/trading members, which again involves communication between the product introduction/supply chain management server 100 and testing/trading member computing devices 600, 700. After a new/introduced product reorder period has expired, in a third process portion 1506 the product introduction/supply chain management server 100 allocates any previous fractional aggregate venture order, plus the new venture orders, to a new aggregate venture order.

A fourth process portion 1510 involves (re)determination or (re)confirmation of a source, MOQ, and cost for the new/introduced product under consideration. A fifth process portion 1512 involves product introduction/supply chain management server 100 adjustment of the new aggregate venture order volume and corresponding proportional adjustment of trading/testing members' individual order quantities in the new aggregate venture order if needed, based upon MOQ and UOM considerations or requirements. A sixth process portion 1514 involves collecting funds for the new aggregate venture order from those testing/trading members participating in the new aggregate venture order.

A seventh process portion 1520 involves determining whether a distributor has been established for the new/introduced product under consideration in the target geographical area 50 under consideration. If not, an eighth process portion 1522 involves placing the new aggregate venture order with the appropriate new/introduced product source. Following the eight process portion 1522, the process 1500 can continue in a manner indicated above with respect to FIG. 7, from the eleventh process portion 1330 therein onward. Referring again to FIG. 9, in the event that a distributor for the new/introduced product has been established in the target geographical area 50, a tenth process portion 1530 involves transferring the new aggregate venture order, and the funds collected therefor, to the distributor. Following the tenth process portion 1530, the product introduction/supply chain management server 100 can designate the new/introduced product as an existing product in the target geographical area 50 under consideration, and issue distributor notifications to testing/trading members participating in the new/aggregate venture order that this new/aggregate venture order, as well as any future orders for the new/introduced product, will be handled by the distributor rather than the product introduction/supply chain management server 100.

### Aspects of a Representative Venture Order—Aggregate Venture Order—Online Sales Example

To further aid understanding, a nonlimiting representative example is considered hereafter. This representative example is directed to the importation of a representative new/introduced product having a brand name of “Farmboy Apple Juice” into a target geographical area 50 such as Singapore, as a result of the receipt and management of venture orders from testing members and trading members in a manner identical, essentially identical, or analogous to that described above. The representative example further considers online sales of this new/introduced product in the target geographical area 50, as well as the apportioned distribution of funds collected from online sales during a current online sales period to each testing/trading member. In this representative example, numerical calculations are appropriately rounded to two decimal places, in a manner readily understood by one having ordinary skill in the relevant art.

Table 1 indicates in a manner in accordance with an embodiment of the present disclosure that the system 10 can receive, manage, and store a set of foundational product parameters for each new/introduced product. In the case of Farmboy Apple Juice, such product parameters include the product brand name and manufacturer; the identity or ID of the discovering seeker; the product's country of origin; and a currency in which an aggregate venture order for the product is to be denominated or must be paid. The set of foundational product parameters also includes a retail selling unit definition; a source cost range per retail selling unit, such as a low source cost and a high source cost; a stock keeping unit (SKU) definition corresponding to a minimum ordering unit for a venture order, and a minimum buyer purchasing unit for online sales; a pallet size definition; and a full container load (FCL) definition. In the case of Farmboy Apple Juice, the retail selling unit definition indicates that the Farmboy Apple Juice is sold (at a retail level) on a per bottle basis; the SKU definition indicates that venture orders and online orders for Farmboy Apple Juice are placed or expressed as a given number of cartons; the pallet size definition indicates that a single pallet includes 55 cartons; and the FCL definition indicates that there are 22 pallets in a single FCL. In this representative example, the low source cost is $0.50 (e.g., from the manufacturer), and the high source cost is $1.50 (e.g., from a distributor or retailer outside of Singapore).

The new product introduction/supply chain management server 100 additionally determines or calculates a number of SKU per FCL; a number of retail selling units per FCL; a low source cost and a high source cost per SKU; and a low cost and a high cost per FCL, which can also be stored as part of the foundational set of product parameters.

The foundational set of product parameters also includes a set of actual or estimated freight and logistics related parameters, such as a foreign pickup and port delivery per FCL charge; customs and local logistics charges, which can include storage, palletization, container unstuffing, and custom clearance charges; and a total freight and logistics charge per FCL.

The new product introduction/supply chain management server 100 additionally determines or calculates a number of estimated or actual landed costs for the new/introduced product, such as at least some of a total low landed cost and a total high landed cost per FCL; a total low landed cost and a total high landed cost per pallet; a total low landed cost and a total high landed cost per SKU; and a total low landed cost and a total high landed cost per retail selling unit. The new product introduction/supply chain management server 100 can further determine an expected, average, or actual landed cost per retail selling unit. The aforementioned landed costs can be stored as part of the foundational set of product parameters. In this representative example, the total low landed cost per retail selling unit is $0.65 per bottle; the total high landed cost per retail selling unit is $1.65 per bottle; and an average landed cost per retail selling unit is $1.15 per bottle.

Table 2 illustrates a representative set of venture order parameters in accordance with an embodiment of the present disclosure, which the new product introduction/supply chain management server 100 maintains for Farmboy Apple Juice, corresponding to venture orders received from testing and possibly trading members, which are collectively indicated in Table 2 as “investors.” In this representative example, such testing/trading members are identified as John, Mary, Peter, Adam, and Louis. As indicated in Table 2, John has submitted a venture order for 20 cartons of Farmboy Apple Juice, and has specified a selling price objective of $2.20 per bottle. Mary has submitted a venture order for 100 cartons of Farmboy Apple Juice, and has specified a selling price objective of $2.10 per bottle. Peter has submitted a venture order for 80 cartons of Farmboy Apple Juice, and has specified a selling price objective of $2.50 per bottle. Adam has submitted a venture order for 1000 cartons of Farmboy Apple Juice, and has specified a selling price objective of $2.90 per bottle. Finally, Louis has submitted a venture order for 800 cartons of Farmboy Apple Juice, and has specified a selling price objective of $3.50 per bottle.

The new product introduction/supply chain management server 100 can additionally determine a total quantity or number of retail selling units corresponding to each of the aforementioned venture orders.

In some embodiments, the new product introduction/supply chain management server 100 determines an administrative fee corresponding to each testing/trading member that has submitted a venture order, as a predetermined percentage of each testing/trading member's selling price objective. Thus, using a predetermined percentage of 3%, the administrative fees corresponding to John, Mary, Peter, Adam, and Louis are calculated as $0.07, $0.06, $0.08, $0.09, $0.11, respectively. In other embodiments, an administrative fee can be determined based upon an average value selling price, as further detailed below.

Based upon each testing/trading member's venture order volume and the estimated, average, or actual landed cost per retail selling unit, the new product introduction/supply chain management server 100 can determine a total landed cost per testing/trading member, which is to be received from each testing/trading member; and a total landed cost for the aggregate venture order. In this representative example, John's total landed cost is 20 cartons, which equals 480 bottles, multiplied by an average total landed cost of $1.15 per bottle to give $552.36. Similarly, Mary's total landed cost is $2761.82; Peter's total landed cost is $2209.45; Adam's total landed cost is $27,618.18; and Louis' total landed cost is $22,094.55. Correspondingly, the total landed cost for the aggregate venture order equals $55,236.36.

In some embodiments, the new product introduction/supply chain management server 100 further determines a cost based weightage corresponding to each testing/trading member, which can be defined as an apportioned landed cost, on a fractional or percentage basis, for each testing/trading member's venture order relative to the aggregate venture order total landed cost. Thus, in this representative example, John's cost based weightage equals $552.36 divided by $55,236.36, or 1.00%. Similarly, Mary's cost based weightage equals 5.00%; Peter's cost based weightage equals 4.00%; Adam's cost based weightage equals 50.00%; and Louis' cost based weightage equals 40.00%.

The new product introduction/supply chain management server 100 can also determine a total expected venture order value corresponding to each testing/trading member, based upon each testing/trading member's venture order volume and selling price objective. Hence, in this representative example, John's total expected venture order value is 480 bottles times $2.20 per bottle, or $1056.00. Similarly, Mary's total expected venture order value is $5040.00; Peter's total expected venture order value is $4800.00; Adam's total expected venture order value is $69,600.00; and Louis' total expected venture order value is $67,200.00. The new product introduction/supply chain management server 100 can further determine a total expected aggregate venture order revenue as the sum of each trading/testing member's total expected venture order value, which in this representative example equals $147,696.00. The new product introduction/supply chain management server 100 can additionally determine a total aggregate venture order product quantity, expressed in retail selling units, as the sum of each trading/testing member's total retail selling unit quantity for the venture order under consideration, which in this representative example equals 48,000 bottles.

In some embodiments, the new product introduction/supply chain management server 100 further determines an expected value based weightage corresponding to each testing/trading member, which can be defined as an apportioned expected value on a fractional or percentage basis of each testing/trading member's total expected venture order value relative to the aggregate venture order total expected revenue. Thus, in this representative example, John's expected value based weightage equals $1056.00 divided by $147,696.00, or 0.71%. Similarly, Mary's expected value based weightage equals 3.41%; Peter's expected value based weightage equals 3.25%; Adam's expected value based weightage equals 47.12%; and Louis' expected value based weightage equals 45.40%.

The new product introduction/supply chain management server 100 can additionally determine an average value selling price per retail selling unit, which can be defined as the total expected aggregate venture order revenue divided by the total aggregate venture order retail selling unit quantity. In the representative example shown, the average value selling price is $147,696.00 divided by 48,000, or $3.08. The new product introduction/supply chain management server 100 can further determine an administrative fee based upon the average value selling price. In this representative example, the administrative fee is 3% of the average value selling price, which equals $0.09.

Depending upon embodiment details, the new product introduction/supply chain management server 100 can utilize each testing/trading member's cost based weightage or expected value based weightage to apportion costs and profits resulting from online sales (e.g., less administrative fees) of Farmboy Apple Juice to each testing/trading member, as further detailed below. For purpose of simplicity and to aid understanding, in this representative example, all product stock corresponding to each testing/trading member who submitted a venture order included as part of the aggregate venture order is initially available for online orders.

Table 3 illustrates a representative set of online orders in SKU for Farmboy Apple Juice received between successive venture reward settlement periods or dates from members designated as buyers, who are collectively indicated as “customers” in Table 3. In this representative example, the buyers are identified as Ken and Judy. As indicated in Table 3, in this representative example, between successive venture reward settlement periods/dates, two online orders for Farmboy Apple Juice were received. More particularly, during a current online ordering period between two venture reward settlement periods/dates, Ken ordered 25 cartons, and hence 600 bottles, of Farmboy Apple Juice; and Judy ordered 100 cartons, and hence 2400 bottles, or Farmboy Apple Juice. The new product introduction/supply chain management server 100 can determine a delivery charge, which in this representative example equals $75.00 for Ken's online order, and $225 for Mary's online order. Similarly, the new product introduction/supply chain management server 100 can determine an administrative/handling charge, which equals $55.00 for Ken's online order, and $222 for Mary's online order. The new product introduction/supply chain management server 100 further determines an online order sales amount for each of Ken and Judy; as well as a combined online order SKU volume, a combined retail selling unit quantity, and a combined online order sales amount for the combination of Ken's online order and Judy's online order. In this representative example, Ken's online order sales amount is $1,976.59, and Judy's online order sales amount due is $7,831.34. The combined online order SKU volume is 125 cartons; the combined retail selling unit quantity is 3000 bottles; and the combined sales amount equals $9,807.93.

Table 4 illustrates a representative manner of apportioning online sales profits among or between testing/trading members, such as the representative testing/trading members who participated in the representative aggregate venture order of Table 2, in accordance with an embodiment of the present disclosure. In various embodiments, the new product introduction/supply chain management server 100 automatically apportions online sales profits to testing/trading members at predetermined venture reward settlement dates, such as on a monthly or quarterly basis. As indicated for the representative example considered in Table 4, the combined online order SKU volume is 125 cartons, and the total distributable online order revenue, which can be defined as the aforementioned combined sales amount less the aforementioned administrative/handling charges in Table 3, equals $9,807.93 minus $277.00, or $9,531.00.

The new product introduction/supply chain management server 100 further determines an apportioned distribution of the total distributable online order revenue, on a fractional/percentage basis, among the testing/trading members who participated in the aggregate venture order, and who have Farmboy Apple Juice inventory available for online sales (e.g., inventory that is stored in a local warehouse 70 associated with the system 10, and which has not been physically delivered to testing/trading member premises within the geographical area 50 under consideration). Such apportioned revenue distribution can be determined in accordance with each testing/trading member's cost based weightage, and/or their expected value based weightage mentioned above.

### Representative Online Sales Revenue Apportionment Using Cost Based Weightages

More particularly, in accordance with John's cost based weightage of 1.00%, John should be apportioned a 1.00% share of the total distributable online order revenue. Thus, as indicated in Table 4, John's 1.00% share of the total distributable online order revenue is 1.00% of $9,531.00, or $95.31. Similarly, Mary's apportioned share of the total distributable online revenue, in accordance with her 5.00% cost based weightage, is $476.55; Peter's apportioned share of the total distributable online order revenue, in accordance with his 4.00% cost based weightage in the aggregate venture order, is $381.24; Adam's apportioned share of the total distributable online order revenue, in accordance with his 50.00% cost based weightage, is $4,765.50; and Louis' apportioned share of the total distributable online order revenue, in accordance with his 40.00% cost based weightage, is $3,812.40.

The new product introduction/supply chain management server 100 additionally determines an apportioned warehouse inventory reduction corresponding to each testing/trading member, in accordance with the combined online order SKU volume and each testing/trading member's cost based weightage within the aggregate venture order, and a corresponding updated warehouse inventory balance based upon such reduction for each testing/trading member. Thus, John's apportioned warehouse inventory reduction on a cost based weightage basis is 1.00% of 125 cartons, or 1.25 cartons; and John's updated warehouse inventory balance on a cost based weightage basis is 20 cartons minus 1.25 cartons, or 18.75 cartons. Similarly, on a cost based weightage basis, Mary's apportioned warehouse inventory reduction is 5.00% of 125 cartons, or 6.25 cartons, and her updated warehouse inventory balance is 93.75 cartons; Peter's apportioned warehouse inventory reduction is 4.00% of 125 cartons, or 5.00 cartons, and his updated warehouse inventory balance is 75 cartons; Adam's apportioned warehouse inventory reduction is 50.00% of 125 cartons, or 62.5 cartons, and his updated warehouse inventory balance is 937.50 cartons; and Louis' apportioned warehouse inventory reduction is 40.00% of 125 cartons, or 50 cartons, and his updated warehouse inventory balance is 750 cartons.

For each testing/trading member, the new product introduction/supply chain management server 100 can also determine a corresponding apportioned retail selling unit quantity in accordance with the combined retail selling unit quantity for the online orders received during the current online order period, relative to each trading/testing member's cost based weightage. Therefore, on a cost based weightage basis, John's apportioned retail selling unit quantity is 30 bottles; Mary's apportioned retail selling unit quantity is 150 bottles; Peter's apportioned retail selling unit quantity is 120 bottles; Adam's apportioned retail selling unit quantity is 1,500 bottles; and Louis' apportioned retail selling unit quantity is 1,200 bottles (out of the 3,000 bottles sold as a result of online orders during the current online order period).

### Representative Online Sales Revenue Apportionment Using Expected Value Based Weightages

In a manner analogous to that described above with respect to cost based weightages, in several embodiments the new product introduction/supply chain management server 100 determines each testing/trading member's apportioned revenue distribution in accordance with their expected value based weightages. With respect to this representative example, in accordance with John's expected value based weightage of 0.71%, John should be apportioned a 0.71% share of the total distributable online order revenue. As indicated in Table 4, John's share of the total distributable online order revenue, on an expected value based weightage basis, is 0.71% of $9,531.00, or $68.14. Similarly, Mary's apportioned share of the total distributable online revenue, in accordance with her 3.41% expected value based weightage, is $325.24; Peter's apportioned share of the total distributable online order revenue, in accordance with his 3.25% expected value based weightage in the aggregate venture order, is $309.75; Adam's apportioned share of the total distributable online order revenue, in accordance with his 47.12% expected value based weightage, is $4,491.37; and Louis' apportioned share of the total distributable online order revenue, in accordance with his 45.50% expected value based weightage, is $4,336.50.

Further analogously, the new product introduction/supply chain management server 100 determines an apportioned warehouse inventory reduction for each testing/trading member, in accordance with the combined online order SKU volume and each testing/trading member's expected value based weightage within the aggregate venture order, and a corresponding updated warehouse inventory balance based upon such reduction for each testing/trading member. Thus, John's apportioned warehouse inventory reduction on an expected value based weightage basis is 0.71%% of 125 cartons, or 0.89 cartons; and John's updated warehouse inventory balance on an expected value based weightage basis is 20 cartons minus 0.89 cartons, or 19.11 cartons. Similarly, on an expected value based weightage basis, Mary's apportioned warehouse inventory reduction is 3.41% of 125 cartons, or 4.27 cartons, and her updated warehouse inventory balance is 95.73 cartons; Peter's apportioned warehouse inventory reduction is 3.25% of 125 cartons, or 4.06 cartons, and his updated warehouse inventory balance is 75.94 cartons; Adam's apportioned warehouse inventory reduction is 47.12% of 125 cartons, or 58.90 cartons, and his updated warehouse inventory balance is 941.10 cartons; and Louis' apportioned warehouse inventory reduction is 45.50% of 125 cartons, or 56.87 cartons, and his updated warehouse inventory balance is 743.13 cartons.

Also analogously, for each testing/trading member, the new product introduction/supply chain management server 100 determines a corresponding apportioned retail selling unit quantity in accordance with the combined retail selling unit quantity for the online orders received during the current online order period, relative to each trading/testing member's expected value based weightage. Therefore, on an expected value based weightage basis, John's apportioned retail selling unit quantity is 21.45 bottles; Mary's apportioned retail selling unit quantity is 102.37 bottles; Peter's apportioned retail selling unit quantity is 97.50 bottles; Adam's apportioned retail selling unit quantity is 1,413.71 bottles; and Louis' apportioned retail selling unit quantity is 1,364.97 bottles (out of the 3,000 bottles sold as a result of online orders during the current online order period).

### Representative Apportionment of Costs of Products Sold Online

In multiple embodiments, the new product introduction/supply chain management server 100 further determines an apportioned cost of products sold online, on a retail selling unit quantity basis, during the current online order period, relative to each testing/trading member's cost based weightage and expected value based weightage. For instance, on a cost based weightage basis, John's apportioned cost of products sold online equals 30.00 bottles times the average landed cost per retail selling unit of $1.15 per bottle, which gives $34.52; and on an expected value based weightage basis, John's apportioned cost of products sold online equals 21.45 bottles times the average landed cost per retail selling unit of $1.15 per bottle, or $24.68. Correspondingly, Mary's apportioned cost of products sold online during the current online order period equals $172.61 on a cost based weightage basis, and equals $117.81 on an expected value based weightage basis; Peter's apportioned cost of products sold online during the current online order period is $138.09 on a cost based weightage basis, and $112.20 on an expected value based weightage basis; Adam's apportioned cost of products sold online during the current online order period is $1,726.14 on a cost based weightage basis, and $1,626.84 on an expected value based weightage basis; and Louis' apportioned cost of products sold online during the current online order period is $1,380.91 on a cost based weightage basis, and $1,570.74 on an expected value based weightage basis.

In various embodiments, the new product introduction/supply chain management server 100 further determines an administrative fee, such as an apportioned administrative fee, corresponding to each testing/trading member for the current online order period. Depending upon embodiment details, an administrative fee or a portion thereof can be calculated using cost based weightages and/or an expected value based weightages. In the representative example under consideration, the administrative fee is determined as 3.00% of each testing/trading member's apportioned retail selling unit quantity of products sold online on an expected value based weightage basis during the current online order period, multiplied by the trading member's selling price objective. Thus, for the current online order period, John's administrative fee can be calculated as 3.00% of John's selling price objective of $2.20, multiplied by John's apportioned retailed selling unit quantity of products sold online on an expected value based weightage basis of 21.45 bottles, which results in an administrative fee of $1.42. Similarly, Mary's administrative fee for the current online order period is $6.45; Peter's administrative fee for the current online order period is $7.31; Adam's administrative fee for the current online order period is $122.99; and Louis' administrative fee for the current online order period is $143.32.

The new product introduction/supply chain management server 100 additionally determines an apportioned profit corresponding to each testing/trading member for the current online order period. In the representative example under consideration, the apportioned profit equals the apportioned online sales revenue, minus the apportioned product cost, minus the apportioned administrative fee. Therefore, John's apportioned profit for the current online order period equals $59.37 on a cost based weightage basis, or $42.05 on an expected value based weightage basis. Similarly, on a cost based weightage basis or an expected value based weightage basis, Mary's apportioned profit for the current online order period equals $297.49 or $200.98, respectively; Peter's apportioned profit for the current online order period equals $235.84 or $190.24 on a cost based weightage basis or an expected value based weightage basis, respectively; Adam's apportioned profit for the current online order period equals $2,916.37 or $2,741.54 on a cost based weightage basis or an expected value based weightage basis, respectively; and Louis' apportioned profit for the current online order period equals $2,288.17 or $2,622,43 on a cost based weightage basis or an expected value based weightage basis, respectively.

The new product introduction/supply chain management server 100 additionally determines an apportioned amount payable to each trader/investor for the current online order period, which in various embodiments equals the apportioned cost of products sold online during the current online order period, plus the apportioned profit from such online product sales. The apportioned amount payable can be determined in accordance with cost based weightages, or expected value based weightages. For instance, in the representative example under consideration, the apportioned amount payable to John for the current online order period equals $93.89 on a cost based weightage basis, or $66.73 on an expected value based weightage basis. The apportioned amount payable to Mary for the current online order period equals $470.10 on a cost based weightage basis, or $318.79 on an expected value based weightage basis. The apportioned amount payable to Peter for the current online order period equals $373.93 on a cost based weightage basis, or $302.44 on an expected value based weightage basis. The apportioned amount payable to Adam for the current online order period equals $4,642.51 on a cost based weightage basis, or $4,368.38 on an expected value based weightage basis. Finally, the apportioned amount payable to Louis for the current online order period equals $3,669.08 on a cost based weightage basis, or $4,193.18 on an expected value based weightage basis.

An individual having ordinary skill in the relevant art will recognize that the cumulative amount payable to all of the testing/trading members who are participating in the venture rewards program by way of online product orders received and completed during the current online order period is the same, regardless of whether the apportioned amounts payable are determined in accordance with cost based weightages or expected value based weightages. The manner in which apportioned amounts payable are determined and/or distributed among testing/trading members can depend upon embodiment details.

In certain embodiments, the new product introduction/supply chain management server 100 can additionally determine a reward or reward amount creditable or payable to the discovering seeker who first submitted a target product verification request corresponding to a new/introduced product under consideration in the target geographical area 50 under consideration, once online orders directed to the new/introduced product for receipt or delivery in the target geographical area 50 have been received. Such a reward or reward amount can be correlated with total online sales for the new/introduced product during an online order period, or an administrative fee. Additionally or alternatively, the new product introduction/supply chain management server 100 can maintain and manage (e.g., in the member database 144) a count and/or a history of new/introduced products each seeker has discovered for the target geographical area 50 under consideration, and can also maintain and manage seeker ratings or rankings that indicate seeker success levels with respect to identifying new/introduced products for this target geographical area 50.

Aspects of particular embodiments of the present disclosure address at least one aspect, problem, limitation, and/or disadvantage associated with exiting systems, apparatuses, circuits, and/or techniques for introducing new products into a target geographical area and/or supply chain management. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, apparatuses, components, processes, or alternatives thereof, may be desirably combined into other different systems, apparatuses, components, processes, and/or applications. In addition, various modifications, alterations, and/or improvements may be made to various embodiments that are disclosed by a person of ordinary skill in the art within the scope of the present disclosure.

1. A method for managing the introduction of a product into a target geographical area in which the product is unavailable from an authorized or recognized distributor, the method comprising:
generating a set of target product verification requests by way of a set of seeker computing devices including a first seeker computing device, each seeker computing device configured for executing an application program for selectively (a) capturing and/or receiving in response to user input information corresponding to a product, including at least one image of the product, and (b) electronically communicating in response to user input a target product verification request over an electronic network to a target product verification request processing system, wherein the target product verification request includes the at least one image of the product and information corresponding to the target geographical area;
receiving a first target product verification request corresponding to a first product from the first seeker computing device at the target product verification request processing system, the first target product verification request including at least a first image of the first product and information corresponding to the target geographical area;
automatically extracting the first image of the first target product from the first product verification request;
determining using the first image of the first product whether the first product is already available for purchase within the target geographical area by way of (a) an authorized or recognized distributor established for the target geographical area, or (b) online orders submitted to an online purchase management system configured for managing online sales of the first product for delivery or pickup in the target geographical area in the absence of an authorized or recognized distributor for the first product in the target geographical area; and
electronically communicating product availability information to the first seeker computing device in the event that the first product is already available for purchase in the target geographical area, the product availability information comprising data corresponding to at least one business or at least one map location within the target geographical area from which the first product is available for purchase.

2. The method of claim 1, wherein determining whether the first product is already available for purchase within the target geographical area comprises automatically submitting the first image of the first product to a search engine or search service providing image-based search and/or recognition functionality.

3. The method of claim 1, wherein the set of seeker computing devices comprises a plurality of seeker computing devices, the method further comprising:
designating the first product as a yet-to-be-identified product;
receiving a plurality of product identification submissions corresponding to the yet-to-be-identified first product from the plurality of seeker computing devices, each product identification submission including a potential product name for the first product;
determining a most frequently submitted potential product name for the first product based upon the plurality of product identification submissions; and
selecting the most frequently submitted potential product name as a most likely or actual name of the first product.

4. The method of claim 3, further comprising:
identifying a reference image corresponding to the first product; and
posting the reference image of the first product to a product recognition/identification graphical user interface (GUI) provided by each of the plurality of seeker computing devices.

5. The method of claim 3, wherein each seeker computing device within the plurality of seeker computing devices is associated with a seeker identifier (ID), the method further comprising:
determining a total number T of seeker IDs associated with the most frequently submitted potential product name;
determining a set of k of seeker IDs associated with earliest product identification submissions within the plurality of product identification submissions that included the most frequently submitted potential product name, where k<T;
associating an electronic credit or award with each seeker ID within the set of k seeker IDs.

6. The method of claim 1, further comprising:
determining using the first image of the first product that the first product is not presently available for purchase within the target geographical area;
receiving at the target product verification processing system a set of subsequent target product verification requests corresponding to the first product and the target geographical area;
and at least one of
automatically determining a current estimated popularity of the first product in the target geographical area; and
automatically determining whether the first product satisfies an estimated popularity criterion with respect to the target geographical area.

7. The method of claim 6, further comprising communicating to the first seeker computing device the current estimated popularity of the first product in the target geographical area and/or an indication of whether the first product satisfied the estimated popularity criterion with respect to the target geographical area.

8. The method of claim 6, wherein determining whether the first product satisfies the estimated popularity criterion with respect to the target geographical area comprises:
determining a cumulative number of target product verification requests corresponding to the first product and the target geographical area that were received during a predetermined monitoring period that temporally extends past the receipt of the first target product verification request; and
determining whether the cumulative number of target product verification requests meets or exceeds a minimum estimated popularity threshold for the first product.

9. The method of claim 1, further comprising:
receiving rating data corresponding to the first product from a set of rating event computing devices at a product rating event at which the first product is presented, each rating event computing device associated with a testing member attending the product rating event;
automatically generating rating statistics corresponding to the first product based upon the rating data; and
automatically communicating the rating statistics over an electronic network to a plurality of testing member computing devices and a plurality of trading member computing devices external to or remote from the product rating event.

10. The method of claim 9, further comprising:
receiving a plurality of venture orders by way of communication between the plurality of testing member computing devices and/or the plurality of trading member computing devices and a venture order processing system, each venture order corresponding to a testing member or a trading member and indicating an order quantity and a selling price objective corresponding to the first product;
generating and placing an aggregate venture order directed to a source for the first product external to the target geographical area based upon the plurality of venture orders;
allocating stock of the first product received in the target geographical area as a result of the aggregate venture order for online sales of the first product that are deliverable or receivable in the target geographical area;
processing online orders for the first product for receipt or delivery in the target geographical area;
determining a distributable revenue amount from online sales of the first product for receipt or delivery in the target geographical area; and
automatically apportioning the distributable revenue amount among testing members and trading members in a manner correlated with testing member and trading member venture orders and allocations of stock of the first product for online sales.

11. The method of claim 10, wherein automatically apportioning the distributable revenue amount comprises apportioning (a) costs or values corresponding to online sales of the first product, (b) administrative fees corresponding to the first product, and (c) online sales profits corresponding to the first product among testing members and trading members in a manner correlated with first product quantities or first product selling price objectives in testing member and trading member venture orders and the allocation of stock of the first product for online sales.

12. The method of claim 10, wherein receiving online orders, determining the distributable revenue amount, and automatically apportioning the distributable revenue amount occurs on a recurring basis in accordance with a predetermined recurring settlement period.

13. The method of claim 12, wherein the recurring settlement period comprises a monthly or a quarterly period.

14. A system for managing the introduction of a product into a target geographical area in which the product is unavailable from an authorized or recognized distributor, the system comprising:
a set of seeker computing devices, each seeker computing device comprising a processing unit, a network communication unit, and a memory storing an application program, which when executed by the processing unit selectively configures the seeker computing device for (a) capturing and/or receiving in response to user input information corresponding to a product, including a set of images of the product, (b) generating a target product verification request corresponding to the product, the target product verification request comprising the set of images and information corresponding to the target geographical area, and (c) electronically communicating the target product verification request over an electronic network in response to user input;
a product database storing product information including a product identifier and product status data with respect to the target geographical area; and
a new product introduction system communicable with the set of seeker computing devices by way of the electronic network, the new product introduction system comprising a set of processing resources, a set of network communication resources, a set of memory resources, and a set of new product introduction program instructions stored in the set of memory resources, which when executed by the set of processing resources configures the new product introduction system for performing new product introduction operations comprising:
receiving from a first seeker computing device a first target product verification request corresponding to a first product and including a set of images of the first product and information corresponding to the target geographical area;
processing the first target product verification request for determining whether the first product is available from an authorized or recognized distributor in the target geographical area; and
automatically determining whether the first product satisfies an estimated popularity criterion with respect to the target geographical area.

15. The system of claim 14, wherein the set of new product introduction program instructions, when executed by the set of processing resources, configures the new product introduction system for processing the first target product verification request by:
automatically extracting a first image of the first product from the first target product verification request; and
automatically submitting the first image to a search engine or search service configured for performing image-based search and/or recognition operations.

16. The system of claim 14, wherein the set of seeker computing devices comprises a plurality of computing devices, wherein the set of new product introduction program instructions, when executed by the set of processing resources, configures the new product introduction system for performing new product identification operations comprising:
designating the first product as a yet-to-be-identified product;
receiving a plurality of product identification submissions corresponding to the yet-to-be-identified first product from the plurality of seeker computing devices, each product identification submission including a potential product name for the first product;
determining a most frequently submitted potential product name for the first product based upon the plurality of product identification submissions; and
selecting the most frequently submitted potential product name as a most likely or actual name of the first product.

17. The system of claim 16, wherein the set of new product introduction program instructions, when executed by the set of processing resources, configures the new product introduction system for performing new product identification operations further comprising:
identifying a reference image corresponding to the first product; and
posting the reference image of the first product to a product recognition/identification graphical user interface (GUI) provided by each of the plurality of seeker computing devices.

18. The system of claim 16, wherein each seeker computing device within the plurality of seeker computing devices is associated with a seeker identifier (ID), and wherein the set of new product introduction program instructions, when executed by the set of processing resources, configures the new product introduction system for performing new product identification operations further comprising:
determining a total number T of seeker IDs associated with the most frequently submitted potential product name;
determining a set of k of seeker IDs associated with earliest product identification submissions within the plurality of product identification submissions that included the most frequently submitted potential product name, where k<T; and
associating an electronic credit or award with each seeker ID within the set of k seeker IDs.

19. The system of claim 14, wherein the set of new product introduction program instructions, when executed by the set of processing resources, configures the new product introduction system for performing new product introduction operations further comprising determining whether the first product is available within the target geographical area by way of online sales of the first product for delivery or pickup in the target geographical area in the absence of an authorized or recognized distributor for the first product in the target geographical area.

20. The system of claim 14, wherein when executed by the set of processing resources, the set of new product introduction instructions configures the new product introduction system for performing new product introduction operations further comprising communicating over the electronic network first product availability information to one or more seeker computing devices within the set of seeker computing devices, wherein the first product availability information comprises data corresponding to at least one business or at least one map location within the target geographical area from which the first product is available for purchase.

21. The system of claim 14, wherein set of new product introduction instructions, when executed by the set of processing resources, configures the new product introduction system for automatically determining whether the first product satisfies an estimated popularity criterion with respect to the target geographical area by:
maintaining a cumulative number of target product verification requests corresponding to the first product and the target geographical area received from seeker computing devices after receipt of the first target product verification request; and
determining whether the cumulative number of target product verification requests corresponding to the first product and the target geographical area meets or exceeds a minimum estimated popularity threshold within a predetermined, selectable, or programmable monitoring period that temporally extends past the receipt of the first target product verification request.

22. The system of claim 14, wherein the set of new product introduction instructions, when executed by the set of processing resources, configures the new product introduction system for performing new product introduction operations further comprising:
receiving rating data corresponding to the first product from a set of rating event computing devices at a product rating event at which the first product is presented;
automatically generating rating statistics corresponding to the first product based upon the rating data; and
automatically communicating the rating statistics over an electronic network to a plurality of computing devices external to or remote from the product rating event.

23. The system of claim 14, wherein the set of new product introduction instructions, when executed by the set of processing resources, configures the new product introduction system for performing new product introduction operations further comprising receiving and processing venture orders for importation of the first product into the target geographical area in the event that the first product is not available from an authorized or recognized distributor in the target geographical area, each venture order identifying an investor having a presence in the target geographical area and comprising an order quantity and a selling price objective for the first product.

24. The system of claim 23, wherein the set of new product new product introduction instructions, when executed by the set of processing resources, configures the new product introduction system for performing new product introduction operations further comprising receiving and processing online orders for the first product for delivery or pickup in the target geographical area in the absence of an authorized or recognized distributor for the first product in the target geographical area, after the importation of the first product into the target geographical area as a result of investors' venture orders.

25. The system of claim 24, wherein when executed by the set of processing resources, the set of new product introduction program instructions configures the new product introduction system for performing new product introduction operations further comprising:
determining a distributable revenue amount corresponding an online order time period during which online orders for the first product for receipt or delivery in the target geographical area were received; and
automatically apportioning the distributable revenue amount among the venture order investors.

26. The system of claim 25, wherein when executed by the set of processing resources, the set of new product introduction program instructions configures the new product introduction system for automatically apportioning the distributable revenue amount among the venture order investors by apportioning (a) costs or values corresponding to online sales of the first product, (b) administrative fees corresponding to the first product, and (c) online sales profits corresponding to the first product among investors in a manner correlated with first product quantities or first product selling price objectives in investor venture orders and an allocation of stock of the first product for online sales.

27. The system of claim 23, wherein the set of new product new product introduction instructions, when executed by the set of processing resources, configures the new product introduction system for performing new product introduction operations further comprising updating status data corresponding to the first product in the product database based upon whether the first product is (a) available from an authorized or recognized distributor in the target geographical area, (b) under consideration for importation into the target geographical area, (c) available in the absence of an authorized or recognized distributor in the target geographical area for receipt or delivery in the target geographical area (i) from venture order investors and/or (ii) by way of online orders.
